(19) United States
(12) Patent Application Publication
(10) Pub. No.: US 2006/0020641 A1
(43) Pub. Date: Jan. 26, 2006

(54) Business process management system and method

(75) Inventors: John Walsh, Silver Spring, MD (US); Jeremy Walsh, Silver Spring, MD (US)

Correspondence Address: PILLSBURY WINTHROP SHAW PITTMAN, LLP, P.O. BOX 10500, MCLEAN, VA, 22102, US

(73) Assignee: Data Quality Solutions, Silver Spring, MD (US)

(21) Appl. No.: 11/141,710

(22) Filed: Jun. 1, 2005

Related U.S. Application Data
(63) Continuation-in-part of application No. 10/396,134, filed on Mar. 25, 2003, now Pat. No. 6,920,474.
(60) Provisional application No. 60/366,547, filed on Mar. 25, 2002.

(51) Int. Cl. G06F 17/30

(52) U.S. Cl. 707/203

(57) ABSTRACT

An business process management system and method for using multiple products or business applications. The business process management system includes a process designer interactive portion configured to receive information for designing a business process, and a process forming portion configured to create or modify the business process based on the information received by the process designer interactive portion. A process forming portion is configured to select a plurality of products or business applications to create or modify the business process. An business process management system and method provide an interface to handle multiple versions of products.

This application is a continuation-in-part of application Ser. No. 10/396,134, filed Mar. 25, 2003, now U.S. Pat. No. ______, which claims priority to U.S. Provisional Application No. 60/366,547, filed Mar. 25, 2002, entitled “Method and System for Enterprise Business Process Management.”

This disclosure contains information subject to copyright protection. The copyright owner has no objection to the facsimile reproduction by anyone of the patent disclosure or the patent as it appears in the U.S. Patent and Trademark Office files or records. However, the owner reserves all remaining copyrights associated with the invention described herein, including all copyrights in the screen displays provided herein to facilitate an understanding of the invention.

### BACKGROUND OF THE INVENTION

1. Field of the Invention

Embodiments of the present invention relate generally to business process management and, more particularly, to methods and systems for computer-based business process management.

2. General Background and Description of Related Art

The automated processing of information has been an enormous benefit to businesses because it has greatly reduced the cost of certain tasks. Every enterprise regardless of whether it is a government, commercial business or not-for-profit organization has the operational necessity to manage information.

This information is used to acquire customers, input orders, ship product, bill customers, collect invoices, pay employees and vendors, order product, audit inventory and maintain records of transactions between employees, customers and suppliers, for example, in the case of a commercial business.

In the normal course of events, information is acquired, processed and consolidated utilizing software, computer hardware and digital networks in accordance with each organization's internal operational model.

Unfortunately, the automated processing of information has also created several problems for businesses, especially where the information in the company's data store is incorrect. Automated processing of incorrect information carries a high cost for businesses in and of itself. In addition, the time, effort, and expense required to correct the undesired results can significantly impact an organization's resources.

Typical examples of the impact of errors on an organization include:
(1) Recipients receive multiple copies of the same offers in the mail, which may result in: (a) the sender wasting postage and printing, and (b) the recipient being negatively affected by waste and, as a result, not ordering products;
(2) Postal systems and other message and package shippers are unable to deliver a significant percentage of their material to the intended recipients, which may have the result that: (a) the product is not delivered on time and returned to shipper due to inaccurate address, (b) costly efforts being made to determine the correct address and repack and reship the product, (c) the invoices are returned and not paid on time or at all, (d) costly efforts are made to determine correct address and resend invoice, (e) clients become annoyed by poor service and, as a result, switch to another vendor, if possible, and (f) customer service, billing, collections, shipping all require additional resources to perform their functions;
(3) Individual operational units contain inaccurate information on clients as well, which may have the result that: (a) enterprise efforts at consolidating information are incomplete, costly and prolonged, and (b) errors in individual operational units, when consolidated, compound the overall error rates and impair the ability for meaningful analysis;
(4) Incomplete and inaccurate information is consolidated in data warehouses, data marts, operational data stores, customer information files and centralized data stores for CRM, ERP, SCM and other centralized processes, which may result in: (a) marketing not being unable to accurately forecast the value and potential of individual clients and client segments and losing valuable market opportunity, (b) customer service not being able to provide the proper service and, as a result, losing clients due to dissatisfaction with service, and (c) fraud not being detected in a timely fashion, resulting in the enterprise being defrauded of large amounts of money;
(5) Operational units are unable to determine the correct tax jurisdiction and tax assignment, which may result in: (a) the enterprises not charging the right tax to the client and paying the right amount to the right authority, (b) taxing authorities not collecting all the proper taxes due them, (c) consumers paying more taxes than they should, and (d) corporations suffering liabilities with tax jurisdictions and clients; and
(6) Customers are unhappy and move to a competitive service.

The impact of erroneous information on a company's revenue is easily explained using a typical mass mailing as an example. Naturally, this is but one example, as the list presented above identifies a number of other potential impacts on a company's revenue.

Companies generate customer lists in a variety of ways. Information collected by one part of an enterprise is often used by other parts of an organization to perform their functions. If the company has a retail component and a catalog component, customer information may be entered into the company's data store at the retail location, at the catalog location, or even through the Internet. Each of these three entry positions presents a location where the information may be erroneous or duplicative of pre-existing information. Any error in the accuracy of information as it is collected, processed and consolidated can impact the effectiveness of multiple functions within an enterprise.

It is possible that a customer may have customer information entered correctly at the retail level. Subsequently, the customer may make a purchase through the catalog division. At that time, the data entry specialist may, for example, enter the customer's name into the data store incorrectly (e.g., by misspelling the person's last name). On still another occasion, the same customer may make a purchase through the Internet. At that time, the customer will be required to supply his or her information for a third time. In this situation, assume that the customer typed his or her last name incorrectly. Therefore, in this scenario, the customer information has been entered three times, two of which were incorrect.

Relying on its stored data, the company then prints and sends an updated copy of its catalog to its customers. Since the customer described has three separate entries in the business's data store, the customer receives three copies of the same catalog. As is easily understood, the cost to the company of printing and mailing the catalog has been tripled simply because of errors in the company's data store.

The problem of data quality exists with many businesses. In the prior art, there have been several approaches offered to minimize the data quality problem.

Previous approaches to data quality include providing a variety of vendor-specific or application-specific functions to the business. The data quality functions are designed specifically to automatically review a company's data, identify errors, in some cases, and correct those errors. To do this in such a way that is flexible to different businesses, the data quality functions typically provide several settings that may be adjusted by businesses to meet their individual needs.

Typically, businesses select a standardized set of settings for a particular data quality function that the business finds most beneficial. The settings may, for example, remove the errors in a data store to “clean” the data store to a point where the data is 95% accurate (which is considered to be a very good result).

The problem of data quality is compounded when a company includes multiple units, each of which have separate data stores that contain overlapping information, and the company tries to create a consolidated data store.

In the example presented above, the company had three business components, a retail component, a catalog component, and an Internet component, each of which contained a separate customer information data store. Typically, if each component wished to “clean” up its data, each component would purchase a data quality solution and apply that solution internally. If each component were to produce a data store that was 95% accurate, the result would be considered quite good.

If the company then tries to create a consolidated data store, a problem arises in that the errors in each data store compound one another. In the case presented, each data store has the same error. The combined data store will have an error rate of 0.95×0.95×0.95=0.857375. This means that the resulting data store has an error rate of about 15%, three times higher than each of the data stores that were combined. As may be appreciated, this problem is particularly pronounced when four or more data stores are combined together.

Furthermore, because the vendor-specific and application-specific data quality functions have unique strengths and weaknesses in detecting and/or correcting errors, the errors may be inadvertently propagated throughout the enterprise as applications pass data back and forth. This may have the undesirable result of causing a multiplicative increase in the overall error rate for the enterprise as a whole.

While data quality solutions are beneficial to the operation of businesses, they are limited in their ability, especially in cases where companies try to create centralized data stores for multiple business entities in an enterprise or group of entities.

Moreover, when a business desires to develop a program to “clean up” its centralized data store, current doctrine dictates that the business retain a firm to develop the appropriate software. The development of software follows what is commonly referred to as the Software Development Life Cycle (SDLC).

The known SDLC adhered to by developers of business processes, such as, for example, data quality processes, results in a time and resource costly lock-step sequential phase approach. For example, a known SDLC includes the following phases which are performed sequentially: requirements definition, general design, detailed design, development, testing, quality assurance checking, trial, implementation, and maintenance/modification. In addition, different personnel or service providers with different skill sets may be required as the project moves from phase to phase. For example, a systems engineer or business analyst may be required during the requirements analysis/definition and test phases, but a software engineer may be required for the design phases. Project handoff between phases introduces errors into the final product and adds cost due to increased project time, increased overhead, and higher project headcount.

Still further, because the requirements definition phase may be arbitrarily halted (i.e., requirements “frozen”) in order to permit design activities to begin, the known SDLC is inflexible and unaccommodating to the evolving needs of customers for software products.

In addition, another failing in the prior art concurs the ability to manage different software upgrades within a business. At present, where software is upgraded, the business simply installs the upgrade.

The upgrade may be problematic on at least two levels. First, the upgrade may occur on only a portion of a business' network. Accordingly, some business units may enjoy the benefit of the upgrade where others do not. Second, it is not uncommon for upgrades to have undesired, and some time catastrophic, impacts on an operating network.

The failings identified above with respect to the prior art cry out for a solution.

### SUMMARY OF THE INVENTION

It is, therefore, one aspect of the present invention to provide a business process management system and method that resolves many of the deficiencies in the prior art.

An enterprise business process management system may include an enterprise business process server coupled to one or more clients, a router, and an interface module. In particular, at least one embodiment of an enterprise business process management system in accordance with the present invention may include an enterprise business process server capable of receiving data from at least one client, at least one router accessible by the enterprise business process server, and at least one business process accessible by the at least one router. The enterprise business process server may be configured to access the at least one business process via the router, to execute the at least one business process on at least a portion of the client data, and to generate business process output data as a function of the at least one business process. The enterprise business process management system may further include an interface accessible by the enterprise business process server which operates with the enterprise business process server to output a process designer interactive page. The process designer interactive page may be configured to accept instructions concerning the at least one business process, to generate process information data, and to provide the process information data to the enterprise business process server. Furthermore, the enterprise business process server may build an instruction set for the business process based upon the process information data.

In accordance with at least one embodiment of the invention, an enterprise data quality management system and method are provided that determine, analyze, enhance, and report qualitative and quantitative aspects of application data and transactional data present in the enterprise.

In accordance with other aspects of the present invention, error reports may be provided at various levels of data processing to identify where data errors are made.

The system and method also provides for a variety of graphical views to present information concerning where errors are made so that businesses may avoid and correct (or at least minimize) those errors in the future.

Furthermore, embodiments of the present invention may provide for a shortened SDLC in which several of the known SDLC steps are combined such that project development time is shortened and the process simplified, resulting in significant time and cost savings.

For example, in one embodiment, the requirements definition, general design, detailed design, and development phases may be accomplished simultaneously in a single phase utilizing an interactive process designer.

Moreover, in one embodiment of the invention, by applying test data to the business processes defined and implemented as described herein, the known SDLC test, quality assurance, and trial phases may be accomplished in a single phase.

In addition, in an embodiment of the invention, each of the SDLC activities may be accomplished through user interaction with one process designer interface provided by a single product.

Furthermore, in an embodiment of the invention, a software engineer may not be required for coding during the project.

Still further, embodiments of the present invention may allow for the reuse of functions from multiple software applications, as well as providing the capability for the user to define a new or modified function of a business process. In at least one embodiment, each such function may be maintained in a function registry or function library and made available to a business process server for subsequent use in defining additional business processes or modified business processes.

Still further, embodiments of the present invention may provide an enterprise to use “best of breed” business processes in combination to achieve increased effectiveness for the overall process. Portions of multiple different business applications may be combined to form a new or modified business process in which the portions are chosen for a particular effect or other such criteria resulting in increased overall effectiveness. For example, several data quality processes, each of which may be obtained from the same or multiple different business applications, may be defined to comprise a single data quality business process that achieves a higher overall data accuracy percentage than would be possible applying each of the multiple data quality business applications alone.

A further aspect of embodiments of the invention is a version graphical display portion that facilitates management of interfaces, releases, and implementations of specific vendors' products, individual functions, and system and user settings.

Still other aspects of the invention will be made apparent from the description that follows and the drawings appended hereto.

### BRIEF DESCRIPTION OF THE DRAWINGS

The benefits of the present invention will be readily appreciated and understood from consideration of the following detailed description of at least one exemplary embodiment of this invention, when taken with the accompanying drawings, in which:

FIG. 1 is an illustrative diagram of a system implementing or employed by the enterprise business process management system in accordance with at least one exemplary embodiment of the invention;

FIG. 2 is a schematic block diagram of equipment that may be used to implement a server designed in accordance with at least one embodiment of the invention;

FIG. 3 illustrates a functional block diagram of an enterprise data quality application of the enterprise business process server in accordance with at least one embodiment of the invention;

FIG. 4 is a functional block diagram illustrating the relationship among data sources/destinations, products, and processes in one embodiment of the invention;

FIG. 5 is a functional block diagram illustrating equipment that may be used to implement a system in accordance with at least one embodiment of the invention;

FIG. 6 is a flow chart illustrating a method used by the enterprise business process management system in accordance with at least one exemplary embodiment of the invention;

FIG. 7 is an example of an error report for an executive view according to at least one embodiment of the invention;

FIG. 8 is an example of an error report for a customer support view according to at least one embodiment of the invention;

FIG. 9 is an example of an error report for an individual view according to at least one embodiment of the invention;

FIG. 10 is an example of an error report for a manager view according to at least one embodiment of the invention;

FIG. 11 is a flow chart of a method of establishing a business process process for the enterprise business process management system in accordance with at least one exemplary embodiment of the invention;

FIG. 12 is an exemplary user interaction page of a graphical user interface for creating a business process in accordance with at least one embodiment of the invention;

FIG. 13 is an exemplary user interaction page of a graphical user interface for adding a data source for a process in accordance with at least one embodiment of the invention;

FIG. 14 is an exemplary user interaction page of a graphical user interface for defining an input packet for a process in accordance with at least one embodiment of the invention;

FIG. 15 is an exemplary user interaction page of a graphical user interface for defining an output packet for a process in accordance with at least one embodiment of the invention;

FIG. 16 is an exemplary user interaction page of a graphical user interface for selecting a product to a process in accordance with at least one embodiment of the invention;

FIG. 17 is an exemplary user interaction page of a graphical user interface for adding a product for use with a process in accordance with at least one embodiment of the invention;

FIG. 18 is an exemplary user interaction page of a graphical user interface for selecting a data destination for a process in accordance with at least one embodiment of the invention;

FIG. 19 is an exemplary user interaction page of a graphical user interface for establishing a process in accordance with at least one embodiment of the invention;

FIG. 20 shows an example process designer interface interactive display for a graphical user interface provided in accordance with at least one embodiment of the invention;

FIG. 21 shows a series of build files utilized in an embodiment of the invention by the enterprise business process server to build a code implementation of a business process;

FIG. 22 illustrates a method of building a new router dynamic link library in an embodiment of the invention;

FIGS. 23a-d are a flow chart illustrating a method of implementing a business process in accordance with at least one embodiment of the invention;

FIG. 24 provides a functional block diagram showing the relationship among functions, processes and products (e.g., tools) involved in the definition of business processes in an embodiment of the invention;

FIG. 25 shows an example of a functions overview interactive page provided in an embodiment of the invention;

FIG. 26 shows an example of a process definition area portion of a process designer interactive page provided in an embodiment of the invention;

FIG. 27 shows an example interactive page illustrating adding an element of a process step from the function library in an embodiment of the invention;

FIG. 28 shows an example interactive page illustrating linking of process steps in the process definition area of a process designer interactive page in an embodiment of the invention;

FIG. 29 shows an example interactive page portion by which a conditional statement may be defined for an element of a process step according to at least one embodiment of the invention;

FIG. 30 shows an example of a products definition interactive page provided in an embodiment of the invention;

FIG. 31 shows an example of a data destination definition interactive page provided in an embodiment of the invention;

FIG. 32 shows an example of a products selection interactive page provided in an embodiment of the invention;

FIG. 33 shows an example of the content of a function template file page provided in an embodiment of the invention;

FIG. 34 shows an example of a function settings interactive page provided in an embodiment of the invention;

FIG. 35 shows an example process tester interactive page according to an embodiment of the invention;

FIG. 36 shows an illustration of a data-populated design area of a process tester interactive page in an embodiment of the invention;

FIG. 37 shows an example of a connection definition interactive page according to at least one embodiment of the invention;

FIG. 38 illustrates a comparison business process in accordance with an embodiment of the invention;

FIG. 39 shows the relationship between the interface module, enterprise business process server, and router in an embodiment of the invention;

FIG. 40 shows a block diagram of an enterprise business process management system in accordance with at least one embodiment of the invention;

FIG. 41 shows a block diagram illustrating a use of multiple products by an enterprise business process management system in accordance with at least one embodiment of the invention;

FIG. 42 shows a block diagram illustrating a use of multiple business applications by an enterprise business process management system in accordance with at least one embodiment of the invention;

FIG. 43 shows an example version display page in accordance with at least one embodiment of the invention;

FIG. 44 shows another example version display page in accordance with at least one embodiment of the invention; and

FIG. 45 shows a block diagram illustrating a use of multiple products having different versions by an enterprise business process management system in accordance with at least one embodiment of the invention.

### DETAILED DESCRIPTION OF THE INVENTION

This application claims priority to U.S. Provisional Application No. 60/366,547 filed Mar. 25, 2002, entitled “Method and System for Enterprise Data Quality Management,” the entire disclosure of which is hereby incorporated by reference as if fully set forth herein.

While the present invention will be described in connection with exemplary embodiments thereof, the exemplary embodiments are not intended to be limiting of the invention. On the contrary, alternatives, modifications and equivalents of the described examples are also intended to be included within the spirit and scope of the invention, which is defined in part by the claims appended hereto.

In accordance with at least one embodiment of the invention, an enterprise business process management system and method are provided. Although at least one embodiment is presented herein in the form of an embodiment of an enterprise data quality management system, it is to be understood that the teachings herein may be applied more generally to any enterprise business process management system, including or in addition to those business processes involved in data quality management. The system and method may utilize a server and an interchangeable router for defining, building and executing steps in business processes, including, for example, steps for detecting, correcting and reporting data errors present in various applications throughout an enterprise. An enterprise may include multiple computing nodes located in different geographic or physical locations that comprise a business organization. The various computing nodes may be interconnected for inter-node communication throughout the enterprise using a network such as, but not limited to, an intranet, the Internet, leased telephone or data lines, a wireless network, or any combination of these. Connected in any of these manners, among others, users associated with the enterprise may obtain transparent, virtual access to enterprise applications, processes, and functions regardless of the physical location of the node or nodes where the applications, processes, and functions reside.

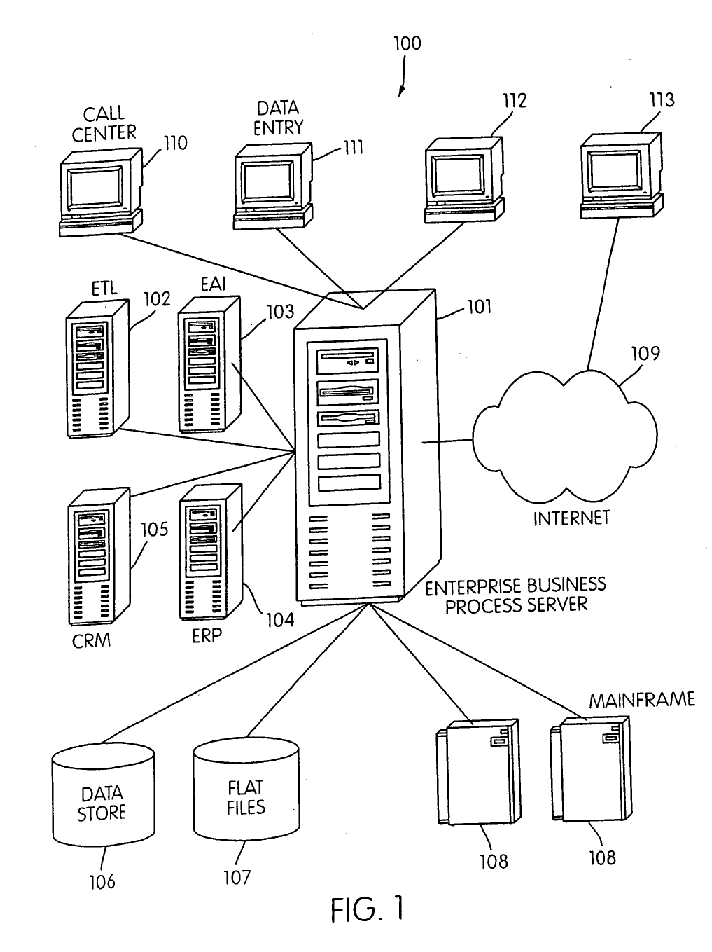

FIG. 1 is an illustrative diagram of a system implementing or employed by the enterprise business process management system in accordance with at least one exemplary embodiment of the invention. Referring to FIG. 1, an enterprise business process management system 100 may include an enterprise business process server 101 coupled to one or more additional clients such as, but not limited to, an Extract, Transform and Load (ETL) client 102, an Enterprise Application Integration (EAI) client 103, an Enterprise Resource Planning (ERP) client 104, and a Customer Relationship Management (CRM) client 105. The enterprise business process server 101 may also be coupled to further additional clients such as a Supply Chain Manager (SCM) client (not shown). Each of the additional clients may include at least one business application. Furthermore, the enterprise business process server 101 may also be coupled to an information data store 106 and a flat files data store 107, one or more mainframes 108, and the Internet 109. In at least one embodiment, the enterprise business process server 101 may also be coupled to one or more terminals such as a call center terminal(s) 110, data entry terminals 111, local user terminal(s) 112, and remote user terminal(s) 113. In at least one embodiment, the enterprise business process server 101 may be an enterprise data quality server or an enterprise business process server configured to allow for the definition and execution of enterprise data quality management.

The enterprise business process server 101 may communicate with enterprise nodes including the additional clients 102-105, the data stores 106 and 107, mainframes 108, Internet 109 and terminals 110-113 using a variety of communications networks including, but not limited to, a network of interconnected networks such as the Internet, a Local Area Network (LAN), a Wide Area Network (WAN), an intranet including any of these, and/or the PSTN, a wireless network, or any combination thereof. In at least one embodiment, the enterprise business process server 101 may communicate with one or more of these enterprise nodes for receiving and transmitting transaction related data as well as error reports, at a minimum.

Generally, the clients 102-105 may be any data source that can send or receive data such as, but not limited to, a server, or a client portion of a client-server application. A client may host one or more business applications processes, or functions of the enterprise, for example. Clients may be located internal or external to an enterprise firewall.

The ETL client 102 may be configured to enable an organization to extract data sets from one data source, map the data to another data source, transform the data if necessary, consolidate data sources, and load the data into the destination source or sources. Such an ETL client 102 may be primarily batch processing oriented and utilize a hub architecture in which the transformations and mappings are performed as the data is passed from its source to its destination.

The EAI client 103 may be configured to enable enterprise transactions to pass from one application to another within an organization/enterprise and from one organization to a partner organization that exists on an EAI network. Such an EAI client 103 may use a hub architecture and include capabilities for mapping and transforming data associated with the enterprise transactions.

The ERP client 104 may be configured to integrate multiple facets of the business or enterprise, including planning, manufacturing, sales, and marketing activities. Such an ERP client 104 may use a hub architecture and include capabilities for mapping and transforming data associated with these activities.

The CRM client 105 may be configured to manage multiple aspects of interaction between the organization/entity and its customers using a variety of electronic-based tools, including help-desk software, sales, marketing, e-mail organizers and Web development applications. Such a CRM client 104 may use a hub architecture and include capabilities for mapping and transforming data associated therewith.

The additional enterprise clients, including the ETL client 102, EAI client 103, ERP client 104, and CRM client 105, may each include vendor-specific application quality checking processes that operate internally to each of the respective server applications. In at least one embodiment, the enterprise business process server 101 may include a Transmission Control Protocol/Internet Protocol (TCP/IP) interface for exchange of information with additional enterprise servers including the ETL client 102, EAI client 103, ERP client 104, and CRM client 105. Information exchanged between the enterprise business process server 101 and the additional clients may include commands or requests from the enterprise business process server 101 to perform one or more particular processes or functions of a process (or processes) such as, for example, processes to check data quality. The exchanged information may also include data output by application quality checking processes or functions. The TCP/IP communication interface may allow the enterprise business process server 101 to connect directly to any application on the enterprise network. Alternatively, the TCP/IP communication interface may allow the enterprise business process server to connect to external applications using, for example, the Internet.

In at least one embodiment, the enterprise business process server 101 may obtain information from the information data store 106 and the flat files data store 107. In particular, the enterprise business process server 101 may include application instructions such as data store scripts for accessing, storing, or selectively retrieving information contained in the information data store 106 and the flat files data store 107. The data store scripts may be implemented in the form of programming statements provided in accordance with, for example, SQL version 7.0 data store management system query language, as well as Transact® SQL (in accordance with the ColdFusion® data store management system). Other data store implementations are possible, including, but not limited to, those available from Oracle® or IBM DB2®.

In an alternative embodiment, the enterprise business process management system 100 may include an enterprise database server (not shown) coupled to the enterprise business process server 101 and the information data store 106 and the flat files data store 107 for the purpose of accessing information stored therein. The information data store 106 may include enterprise application or transactional data arranged in accordance with a hierarchical data store management system format such as, for example, SQL. The flat files data store 107 may include enterprise application or transactional non-hierarchical data.

The enterprise business process server 101 may also be coupled to one or more mainframes 108 in the enterprise. The mainframe(s) 108 may include organization or enterprise applications such as, for example, legacy payroll or accounting systems. In at least one embodiment, the enterprise business process server 101 may communicate with the mainframe(s) 108 using a Local Area Network (LAN), a Wide Area Network (WAN), dedicated landlines, or a combination thereof, among others.

Furthermore, in at least one embodiment the enterprise business process server 101 may also be coupled to one or more terminals such as a call center terminal(s) 110, data entry terminals 111, local user terminal(s) 112, and remote user terminal(s) 113 via LAN, WAN, dedicated landlines, an intranet, the Internet, a wireless network, or a combination thereof. The enterprise business process server 101 may thereby receive transactional data from one or more of the terminals 110-113.

In addition, the enterprise business process server 101 may communicate with users at one or more remote terminals 113 using, for example, the Internet 109. In at least one embodiment, the enterprise business process server 101 may further include a web browser or thin client for this purpose. The web browser displays data and is capable of communicating with other computers via a network such as, for example, the Internet or an intranet. The web browser may provide a user with a way to navigate, via, for example, hyperlinks which are selected by a pointing device (such as a computer mouse) or typed in by the user. The web browser may use a protocol such as, for example, HyperText Transfer Protocol (HTTP) or File Transfer Protocol (FTP), to transmit data of various content such as, for example, HTML formatted documents, plain text documents, graphic images, and XML documents for presentation to a user via a display.

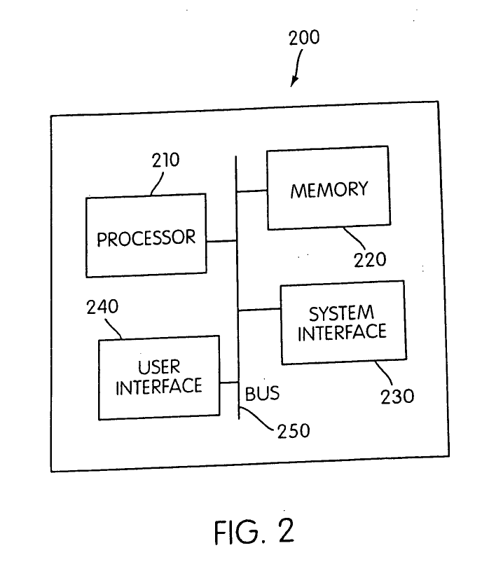

FIG. 2 illustrates a computing platform that may be used to implement the enterprise business process server 101 in accordance with at least one embodiment of the invention. As shown in FIG. 2, the equipment 200 may include a processor 210, a memory 220, a system interface 230, a user interface 240 and a communication/data/control bus 250 that couples elements 210-240 together and allows for cooperation and communication between those elements.

The memory 220 may be implemented utilizing alternative configurations depending on the needs of a user or a system associated with the enterprise business process management system. The system interface 230 may include both hardware and software to allow the equipment 200 to communicate with components that provide data utilized by the enterprise business process management system, for example, transactional data feeds from the additional enterprise servers.

The processor 210 controls operation of the other elements 220-250, based on instructions fetched from the memory 220. The instructions may include or be implemented as software code that dictates some or all of the operations of the enterprise business process management system 100 and method explained herein. The memory 220 may include this code and may also include storage area for data utilized by or generated by the enterprise business process management system 100. The processor 210 may fetch the instructions, decode them, and act or instruct other elements 120-150 to, for example, transfer data to or from the memory 220 or to work in combination with the system interface 230 or the user interface 240 (for example, to input or output information), etc.

The processor 210 may actually be implemented as more than one processor. The processor 210 may, based on instructions fetched from the memory 220, operate to control operation of the other elements 220-250. It should be appreciated that control may be implemented with the processor 210, for example, in a central processing unit, or other similar device. Similarly, the processor 210 and the memory 220 may be implemented via one or more servers coupled to a network that allows the user interface 240 to be implemented at a user terminal, such as local terminal 112 and remote terminal 113, and include a Graphical User Interface (GUI) on a terminal screen.

The user interface 240 may include, for example, hardware and software for cooperating with a terminal display, a keyboard and mouse, printer, etc. Moreover, the user interface 240 may include a speaker and microphone, not shown, for outputting and inputting information to and from a user. The user interface 240 may operate in conjunction with the processor 210 to allow a user to interact with software programs stored in the memory 220 and used by the processor 210 so as to perform the operations explained below.

The enterprise business process server 101 can be implemented, for example, as portions of a suitably programmed general-purpose computer. The system may be implemented, for example, as physically distinct hardware circuits within an ASIC. Thus, it should be appreciated that the particular form of the system 100 may differ from the embodiment(s) explained herein. For example, although the enterprise business management system 100 has been described as being implementable on a general-purpose computer, for example, a personal computer, it is foreseeable that the system may be implemented in a network environment where the software implementing the system is stored on one or more servers. In at least one embodiment, the enterprise business process server 101 may allow a user (e.g., an administrative user) to add, modify, or delete business process processes or steps without taking down the server 101. Furthermore, the enterprise business process server 101 may be scalable in order to easily function within server array or cluster environments and for processing of large volumes of data. In at least one embodiment, the enterprise business process server 101 may include a Microsoft Windows™ NT enabled personal computing platform, for example.

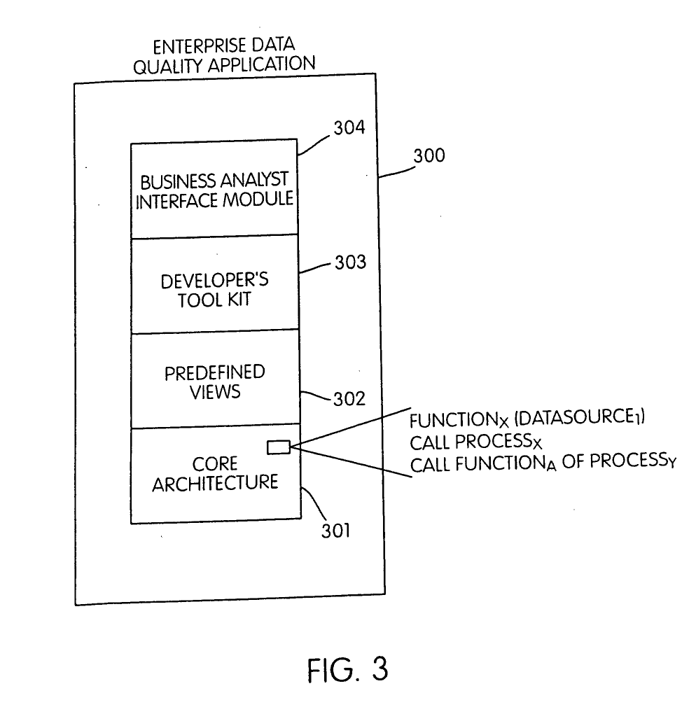

In at least one embodiment, the enterprise business process server 101 may include one or more applications programs containing a series of programmed instructions that cause the enterprise business process server 101 to be configured to perform the business process operations as described herein. In particular, in at least one embodiment, FIG. 3 illustrates a functional block diagram of an enterprise data quality application 300 of the enterprise business process server 101. Referring to FIG. 3, the enterprise data quality application 300 may include a core architecture 301, a set of predefined view tools 302, a developer's kit 303, and an interface module 304, which may be a business analyst interface. The core architecture 301 may include a series of programmed instructions for obtaining application data or transactional data from one or more data sources, analyzing the obtained data for errors, logging detected errors, and generating at least one error report according to a particular requested view. The enterprise data quality application 300 may include one or more functions designed to analyze a particular type of application data, which may be obtained from one or more data sources, for occurrences of one or more types of errors present in the application data. In addition, the enterprise data quality application 300 may include instructions causing a request to be transmitted to one or more of the additional enterprise servers, including the ETL server 102, EAI server 103, ERP server 104, and CRM server 105, requesting execution of a particular application's internal quality checking processes or a particular set of functions of one or more of the application's internal processes. In at least one embodiment, the enterprise business process server 101 may transmit commands/requests (e.g., function calls or procedure calls/Remote Procedure Calls (RPCs)) and receive responses from the associated server via the TCP/IP interface. The core architecture 301 may include a multi-threaded management layer for automatically converting any legacy applications that are not multi-threaded to multi-threaded capabilities.

In an embodiment, the business analyst module 304 may include a sequence of programmed instructions to implement the interface module (e.g., business analyst interface or BAI) described herein. These instructions may, upon execution by the enterprise business process management server 101, cause the enterprise business process management server 101 to provide an interactive means to facilitate user interaction with the enterprise business process management system 100. In particular, the business analyst module 304 may include instructions operable to cause process steps to be represented graphically, for example, using a display, and indicative of a particular operation to be accomplished by the enterprise business process server when executing one or more process steps of a business process. As such, the business analyst module 304 may be an overlay application to the developer's kit 303. The business analyst module 304 may also include instructions operable to cause the enterprise business process server 101 to retrieve, build and compile from a data store such as, for example, the data store 106, a sequence of instructions implementing the business process defined by a user interacting with the interface module.

In at least one embodiment, the enterprise business process system 100 may output error information in the form of one or more error reports. Error reports may be presented in accordance with a variety of views. The predefined view tools 302 may include programming instructions associated with one or more error reports provided in accordance with a predefined set of views. For example, the predefined view tools may provide instructions that cause the enterprise business process server 101 to output an error report including a numeric count of errors for a data source for a manager's view. Further exemplary views and reports are described hereinbelow.

The developer's kit 303 may include an Application Programming Interface (API) useful for users of the enterprise business process system 100 or their designated third parties to create and use customized view tools for analyzing particular data, sources, error syndromes, or for providing customized reports over and above the set of predefined view tools 302. There is no limit on the number of views supported by the enterprise business process management system 100.

In at least one embodiment, the enterprise business process server 101 may be implemented in accordance with a client-server architecture. Programmed instructions, including the enterprise data quality application 300, may be implemented in portable source code such as, but not limited to, generic Microsoft® C. The enterprise business process server 101 may be implemented in accordance with an encapsulated server design in order to support clusters and server arrays. Furthermore, the enterprise business process server 101 may be implemented in accordance with a stateless architecture approach to allow use of third-party technology for load balancing and high availability, for purposes of providing reliability and scalability to handle huge volumes of data. In addition, the enterprise business process server 101 may utilize “sandbox technology” (i.e., use of a combination of process synchronization and isolation techniques such as, for example, handling each session via a separate thread) to allow legacy technology that was not multi-threaded, or even thread-safe, to be quickly and reliably added to the real-time, parallel processing environment.

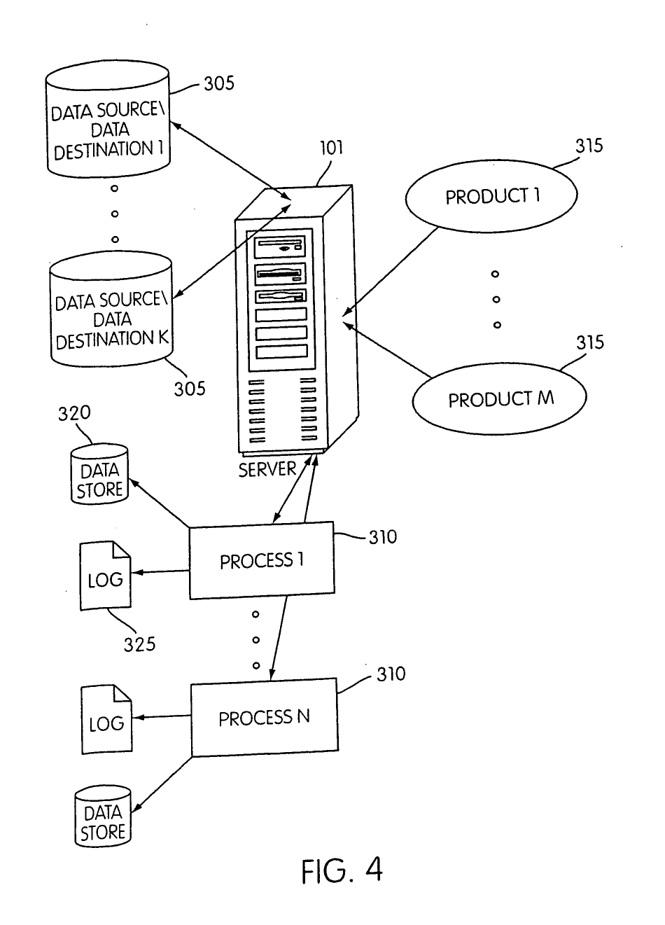

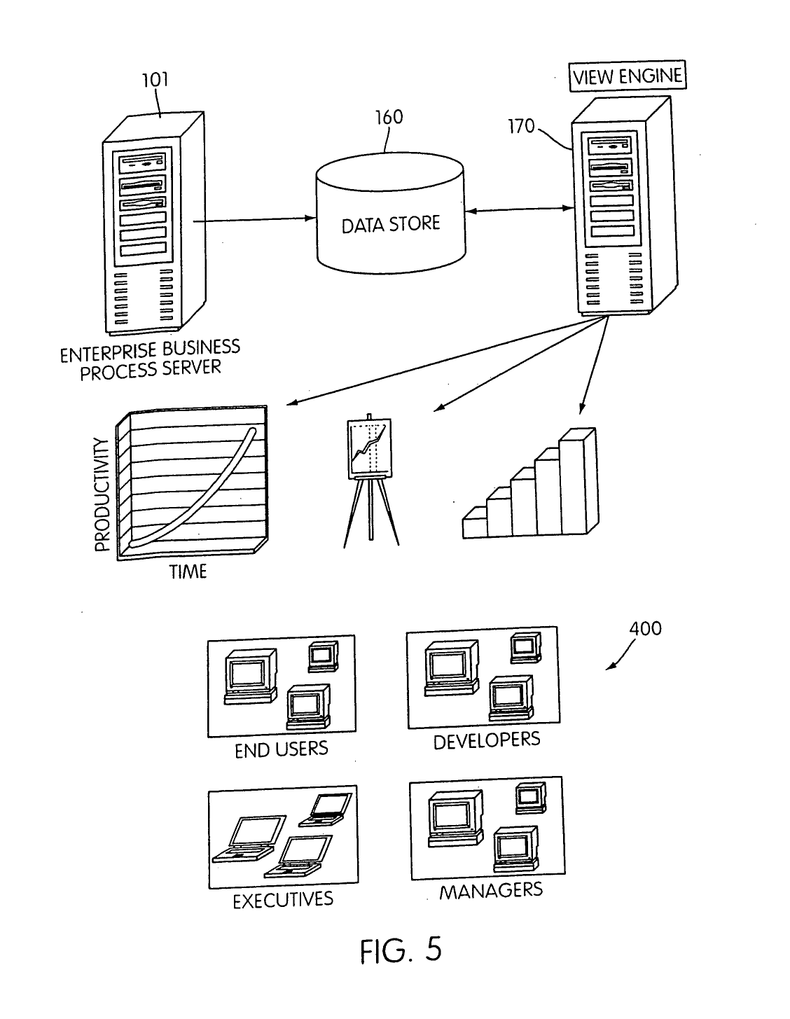

FIG. 4 is a functional block diagram illustrating one contemplated relationship among data sources/destinations, products, and processes according to at least one embodiment of the invention. As shown in FIG. 4, the enterprise business process server 101 may receive enterprise application or transaction data from and transmit to one or more data sources/destinations 305. In at least one embodiment, the enterprise business process server 101 may provide corrected data following detection of an error to a data source/destination 305 (e.g., data source/destinations 1 through K). Furthermore, the enterprise business process server 101 may receive process input from one or more products 315 (e.g., Products 1 through M). A product 315 may include a function or set of functions. In at least one embodiment, a function may be a routine in a library that returns a value or set of values. In addition, the enterprise business process server 101 may include or access one or more processes 310 to perform, for example, the data quality assurance functions described herein (e.g., Processes 1 through N). In at least one embodiment, the enterprise business process server 101 may provide an individual error log 325 for each process 310. Results from each process 310, including any error log 325 generated, may be stored and maintained using a log data store 320 (which may be the data store 160 described with respect to FIG. 5).

The enterprise business process management system 100 may include an architecture designed to utilize an unlimited number of different vendors' products in a unique process for each application (data source) or data set within an application. In particular, the enterprise business process management system 100 may provide a framework for a unique process that creates, executes, manages and reports on individual process steps in a business process that utilizes different vendors' products on various platforms and enables these products to be used across the entire enterprise. The enterprise business process management system 100 may provide archiving or logging of the quality of the data being processed at each step in a multi-vendor environment. The enterprise business process management system 100 may allow for managing, tracking and reporting on the use of multiple vendors' products in a unique process for any application (data source) or data set within an application. The enterprise business process management system 100 may provide for the utilization of the same functions from the same or multiple vendors with different settings in a process. The enterprise business process management system 100 may provide different views on the performance of individuals, business units, or special constituencies within an organization and the enterprise in regard to particular aspects of the business process such as, for example, data quality. The enterprise business process management system 100 may provide for comparisons of the effectiveness of various functions and settings from different vendors for the selection of the most effective functions and settings to handle a specific enterprise issue, such as, for example, a data quality issue. The enterprise business process management system 100 may provide for the fast implementation of multi-vendor applications, such as data quality tools and data quality processes.

In particular, the enterprise business process server 101 may utilize a vendor independent architecture that allows for business process tools to be used either on their current computer platform or on the same platform that hosts the enterprise business process server 1101. In at least one embodiment, the enterprise business process management system 100 provides for reuse of functions of multiple business applications in system 100 defined business processes.

FIG. 5 illustrates equipment that may be used to implement a system in accordance with at least one embodiment. In particular, the enterprise business process system 100 may include not only the enterprise business process server 101, but may also include a data store 160 and a view engine 170. The data store 160 need not be a single data store but may comprise several data stores together. For example, the data store 160 may be, but is not limited to, an OLAP (On-Line Analytical Processing Database) or a Summary Database. The data store 160 may include, but is not limited to, formatting instructions and rules used by the view engine 170 to produce an error report according to one of several views 400. For example, the view engine 170 may obtain from the data store 160 a sequence of formatting instructions and apply the thus-obtained instructions in generating an error report according to the associated view 400. In at least one embodiment, each view 400 may be associated with a particular set of formatting instructions. The formatting instructions may be implemented in the form of HyperText Markup Language (HTML) or Extensible Markup Language (XML) instructions designed to cause the view engine 170 to render an interactive page containing the requested error report according to the desired view. The interactive page may be, for example, a world wide web page, or a page capable of display at a terminal 112 or 113 using a web browser application.

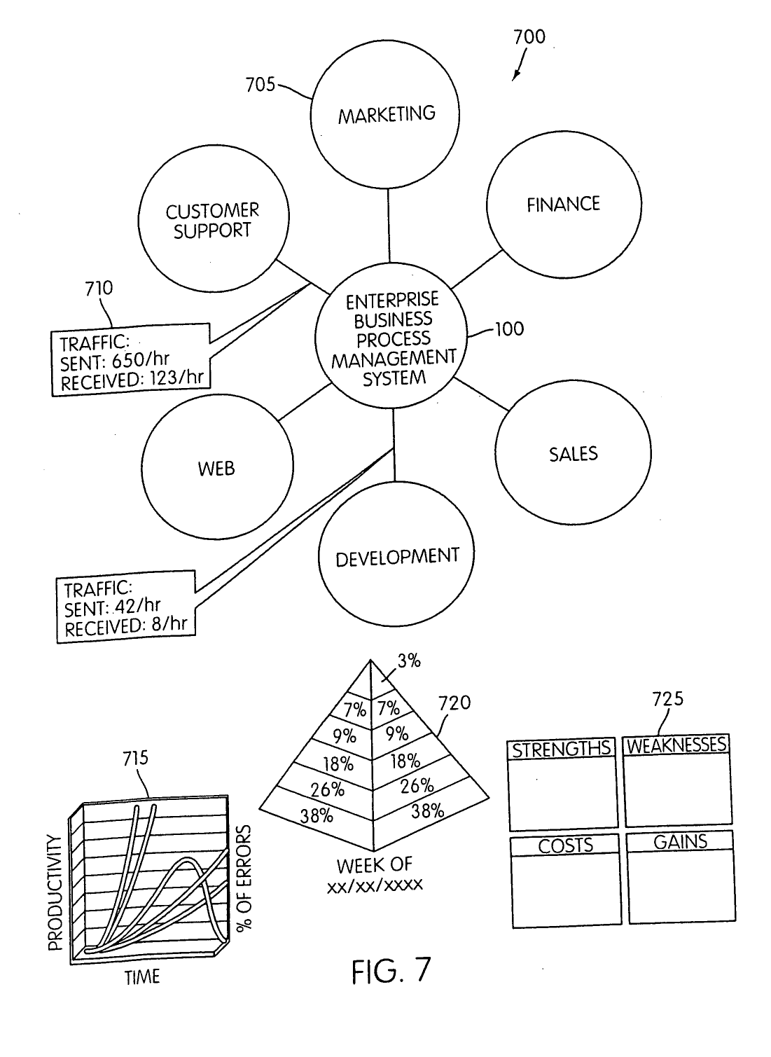

As can be seen in FIG. 5, the enterprise business process management system 100 may provide several different views 400, including, but not limited to, an end user view, a developer view, a manager view, and an executive view. Exemplary views 400 are described in further detail with respect to FIGS. 7-10 below.

The enterprise business process management system 100 may provide the ability to create different views 400 of the results of each step in a process for different levels of an organization to permit the measurement and management of the effectiveness of the organization's business processes. The enterprise business process management system 100 may include visualization software that creates graphical information for the different views 400. This graphical information may include analytical tools, statistical information, data tracking, cost analysis and, in at least one embodiment, an indication of the impact of the results of the different levels of the organization in reducing the errors in data quality.

In order to support the generation of error reports in accordance with a variety of views 400, the data store 160 (which may be an online application processing database or summary database) may maintain error report information in accordance with a “single view” in which information contained in the data store 160 is formatted and arranged in a consistent manner equally accessible by the view engine 170 for the production of any view 400, regardless of the data source/destination 305, product 315, or process 310 from which the data was obtained.

The enterprise business process management system 100 may log the results of each step in a process from every data source. This log may provide information regarding who sent the data, what occurred during each step of the process, and where the data was sent after the process was completed. This log may feed directly into the view engine 170, which may be a graphical reporting system, for rendering of multiple views.

In at least one embodiment, view engine 170 may provide graphical reports to various users including executives, managers, end users, and process developers that convey information regarding how they, their department, organization or processes are performing. In particular, in at least one embodiment, view engine 170 may provide the following views 400, for example views for Executives, Managers, Users, and Developers. The Executive View provides graphical reports on the quality of data for the whole organization. Executives can drill down into the performance of every segment within the organization to compare performances and causes of data quality issues. Executives have access to Manager and User Reporting modules as well. The Managers View provides graphical reports on the quality of data in the manager's organization(s) and department(s). Managers can drill down into the performances of their business units and departments and compare performances and causes of issues such as, for example, data quality. The Users View provides graphical reports on the quality of the data that has been entered by users into the system. Users can drill down on the specific problems and review the input and output data and result codes of each step in the process. The Developers View provides graphical reports on the results of all processes and steps so that developers may analyze the results and make changes to the process to improve the results. Developers can readjust the sequences of functions, eliminate functions, utilize functions from other vendors, add new functions from different vendors and create new functions themselves.

The view engine 170 may include statistical modeling packages that can be used to add the financial impact of data that is validated/corrected and not validated/corrected. In at least one embodiment, the view engine 170 may be implemented using graphical modeling technology available from, for example, Illumitek™ Corp. of Dulles, Va.

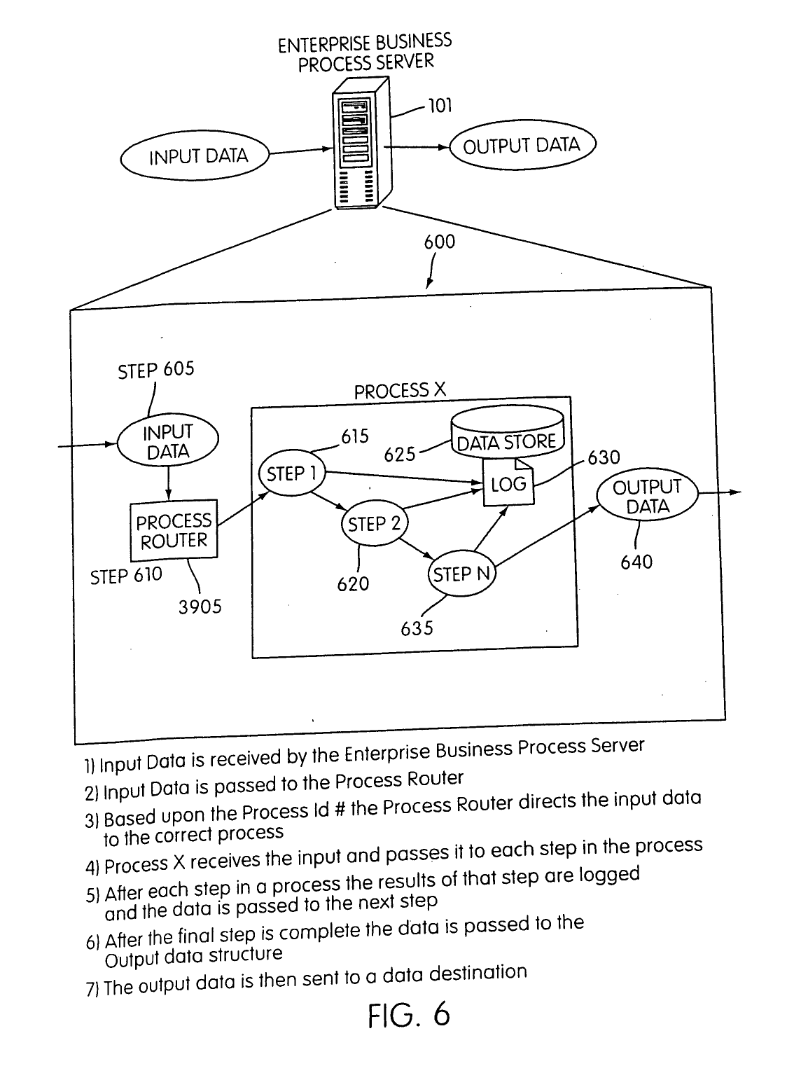

FIG. 6 provides further details concerning implementation of the analysis that may be performed by the enterprise business process management system 100. The enterprise data quality management system 100 may provide for the creation of a unique process for each application or data set from that application using all or a subset of the functions and settings available within all the business process products present in the enterprise network and externally available. Each application or data set within an application is capable of utilizing all the functions and settings in a sequence appropriate for meeting unique needs. Such business processes may be composed of an unlimited number of steps. Each step may correspond to a function and setting or a series of functions and settings from a particular vendor. The enterprise business process management system 100 may provide archiving and logging of the results of every step in a multi-vendor process. Log files may be automatically logged to a text file or a data store. In particular, errors may be determined and logged at the process level.

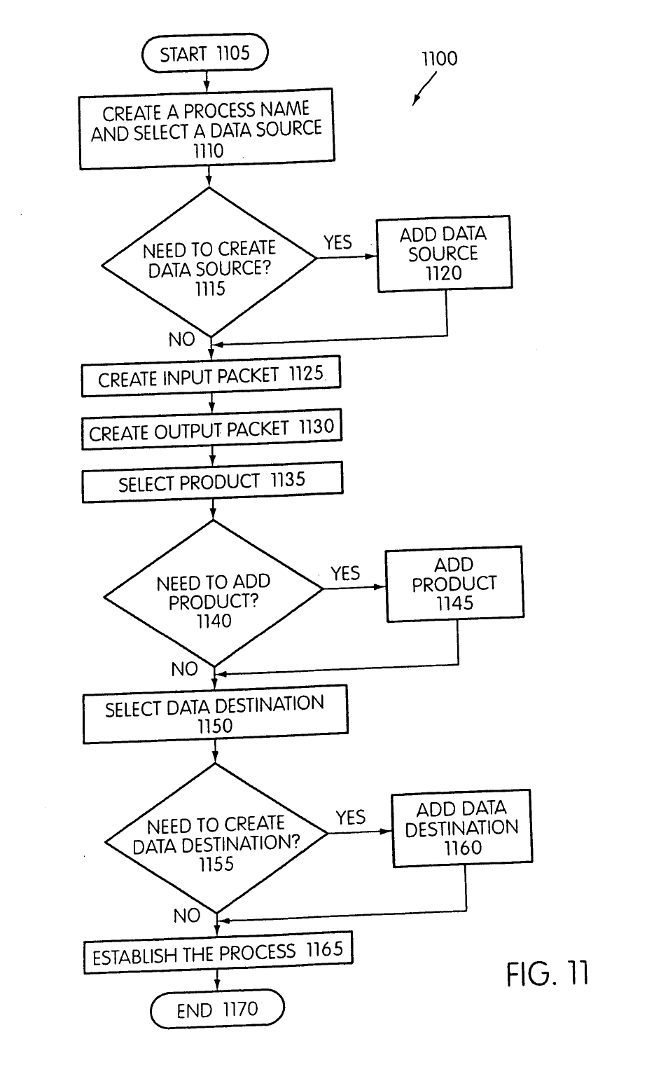

The enterprise business process management system 100 may include the ability to compare the strengths and weaknesses of each vendor's functions and settings in a multi-vendor, multi-step process. Furthermore, the enterprise business process management system 100 may provide a fast, easy to use methodology for installing products and functions from multiple vendors to expedite the implementation of business process projects. Thus, in at least one embodiment, the enterprise business process management system 100 may be vendor independent while allowing users access to all the functions included in additional enterprise servers or application, including existing business process vendor products, custom codes, or services. Through use of the function oriented approach as described herein, a user may sequence the business process functions, such as, for example, data quality functions, from different vendors in any order determined to fit the needs of each data set and data source. Furthermore, a user may establish unique processes 310 and steps for each data set within a data source as described with respect to FIG. 11.

A vendor may be a software company that provides functionality to, for example, identify and separate into distinct fields the elements of a business and consumer name; identify, separate, validate and correct each element of an address; identify, separate, validate, correct and transform non-name and address information for on-line transactions and batch processing; consolidate data from different records and different data sources; augment the original data with additional data; and create a single record or view of that individual or client.

The enterprise business process management system 100 may include a Graphical User Interface (GUI) capable of allowing a user to create a process for an application or data set from an application. The user may specify the format for the data, and may also create individual steps in a process by calling a specific function(s) and setting(s) from an available tool for each step. The GUI may be implemented using Java® instructions, for example. The user may repeat the exercise of creating steps until a business process process is fully defined and completed. The process may be represented, viewed and navigated in a hierarchical fashion where a single step may represent a multi-step sub process. The process depiction and description may be presented on other output devices, such as printer. The process depiction and description may be exported for viewing and manipulation by external applications, such as a word processor, flow chart application, or web browser. The user may then identify the destination(s) for the results of the process and decide what information is to be sent to each destination. The results of each step within a Process may be logged to a text file or data store. The data that is stored in the text file or data store may used by a view engine, which may include visualization software, to create graphical reports, which contains analytical information, statistical information, data tracking, cost analysis, and the impact of data for the different levels within an organization. This information may be used to measure and monitor the effectiveness of an enterprise business process such as, for example, a data quality program.

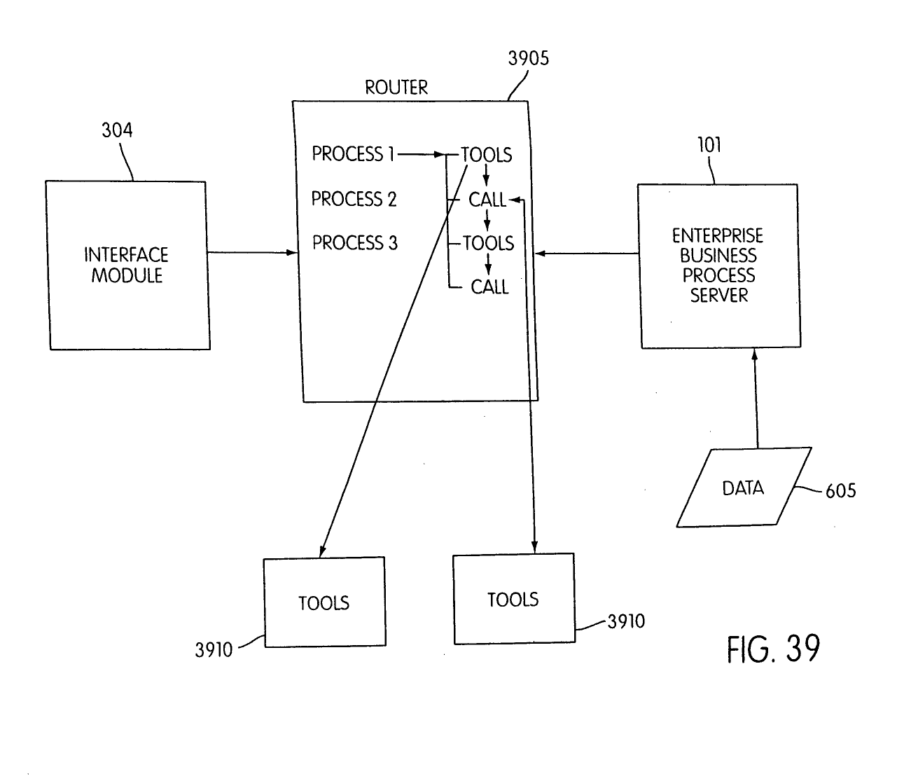

FIG. 39 shows the relationship between the interface module 304, enterprise business process server 101, and router 3905 in an embodiment. Referring to FIG. 39, input data 605 from a data source such as, for example, a business application, may be received by the enterprise business process server 101. In an embodiment, the input data 605 may include a process identifier specifying a particular business process to which the input data 605 is to be applied. The enterprise business process server 101 may be configured to detect the input data 605 process identifier and provide the input data 605 to the specified business process of the router 3905. In an embodiment, the router 3905 may include an integrated instruction set embodying one or more business processes (e.g., processes 1, 2 and 3 are shown in FIG. 39). The instructions for each business process may include calls to tools 3910 (i.e., functions) residing external to the router 3905 for performing process steps, as well as tools 3910 obtained from business applications external to the router 3905 but residing on the router 3905.

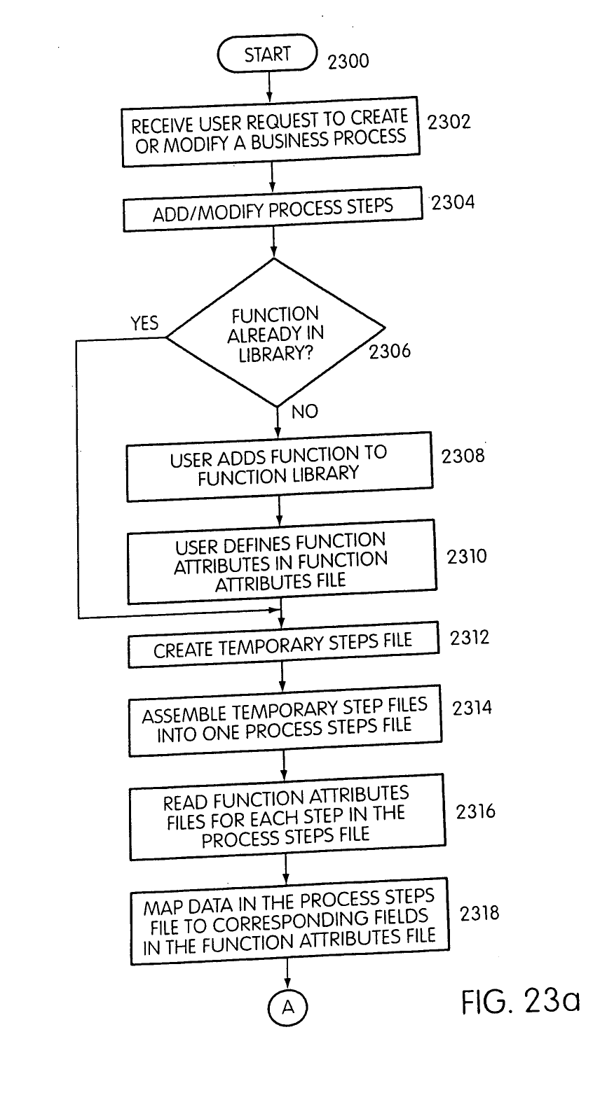

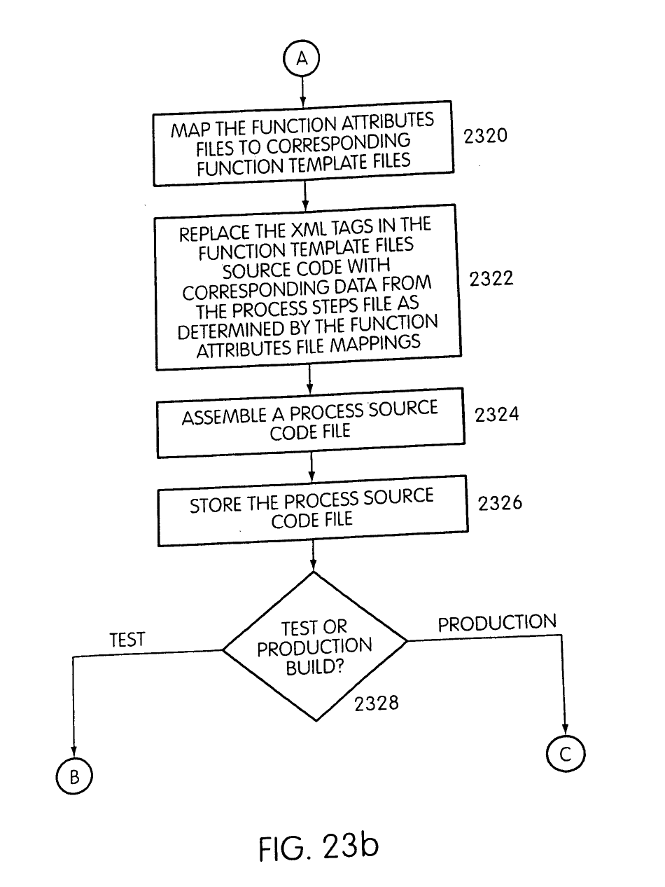

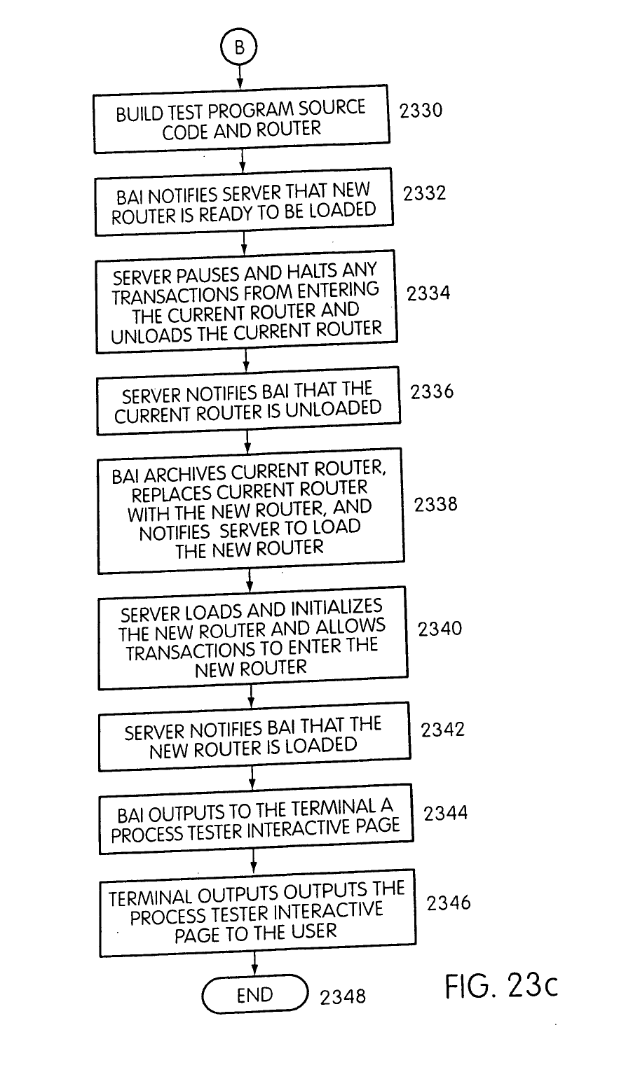

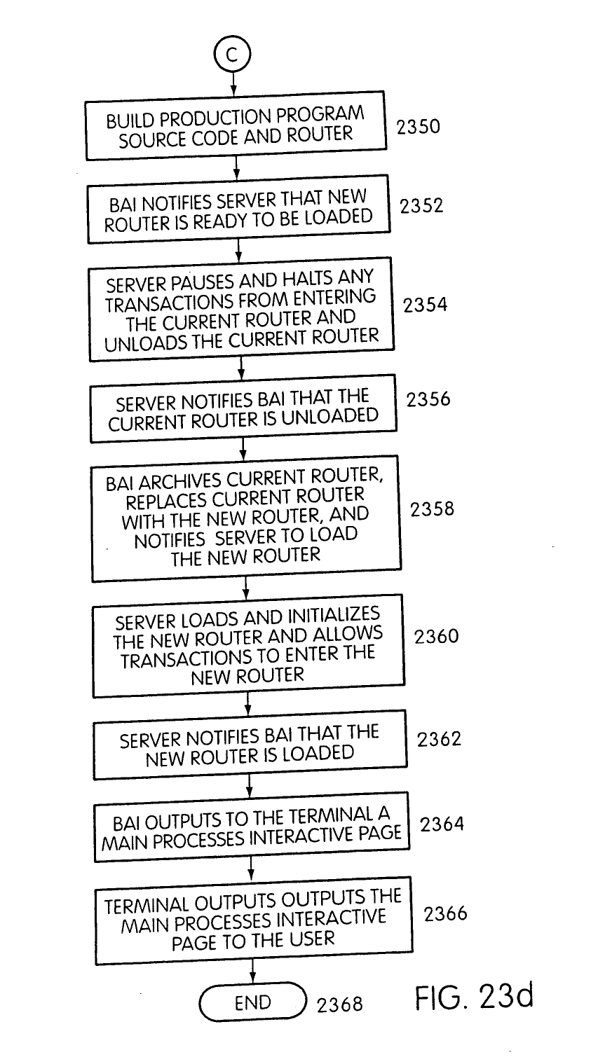

In at least one embodiment, the router 3905 may be an interchangeable router in which new versions or loads for the router 3905 may replace the current router 3905 version, and be placed in service and handle data traffic, without the need to take the server 101 down (i.e, out of service). The router 3905 may include the instruction set for the currently active business processes provided by the enterprise business process management system 100. A new router 3905 version may be built and placed into service to begin data traffic handling according to a new or modified business process. In an embodiment, the interface module 304 may generate an instruction set embodying a new or modified business process in response to user entered function information. The user may enter the function information using, for example, a process designer interactive page provided by the interface module 304. Following replacement of the current router version with a new router version, input data 605 may be handled according to the new router version. Further details concerning the replacement of a current router version with a new router version are described with respect to FIGS. 23a-d herein.

Referring to FIG. 6, a method 600 may commence with the enterprise business process server 101 receiving input data at 605. The input data 605 may be received from a data source/destination 305.

Control may then proceed to 610 at which the input data may be passed to a process router. Based on a process identifier, the process router may direct the input data to a particular process 310 (e.g., Process X). In at least one embodiment, the process router may allow processes and steps to be easily and quickly modified without bringing down the server 101 (i.e., an interchangeable or hot swappable router).

Control may then proceed to 615, at which the process 310 (e.g., Process X) may receive the input data and pass it to each step in a multiple step process. An example of a business process is a data quality process such as an address validation operation in which transactional data (obtained from a data source/destination 305 associated with a particular enterprise application) is compared to a trusted source such as, for example, a United States Postal Service database. Control may then proceed to a second step at 620 and thereafter to subsequent steps (e.g., Step N) at 635. After each step in the process 310, the results of the step may be entered into a log 630, such as, for example, error log 315, and the data is passed to the next step. The results of each step of the process 310 and the error log 315 may be maintained in a data store 625, such as the data store 160. As mentioned above, the data store 625 (and the data store 160) may be, but is not limited to, an OLAP (On-Line Analytical Processing Database) or a Summary Database. Logging may include server Logging (e.g., logging of all transactions received by the server, logging of server statistics) as well as process logging (e.g., detailed logging of each step within a process that can be used for analysis on transaction data and product abilities).

After the final step in the process 310 has been completed, control may proceed to 640 at which the process results may be applied to an output data structure. The output data may then be provided to a data source/destination 305, following which processing may end for the method 600.

In at least one embodiment, a process 310 may include fields such as, but not limited to, ROME_ID, ROME_TIME, SECT_CODE, SOURCE_DEST, SUB_SOURCE_DEST, RETURN_CODE, and INPUT COMPONENT 1-N. Each step in a process 310 may include fields such as, but not limited to, ROME_UID, ROME_TIME, PRODUCT_ID, PRODUCT_RC, STEP_ID, and OUTPUT COMPONENT 1-M. Each data packet may have a unique identifier (e.g., “ROME_ID”) that can be used to track the results of multiple submissions of the same data packet.

As described earlier herein with respect to FIG. 5, for example, in at least one embodiment, the enterprise business process server 101 may provide error reports in accordance with one or more views 400. FIG. 7 is an example of an error report for an executive view according to at least one embodiment of the invention. As shown in FIG. 7, an executive view 700 may include one or more error reports providing data error information for a variety of divisions 705 of an enterprise. For example, the exemplary executive view 700 shown in FIG. 7 may present an error report for divisions 705 including marketing, finance, sales, development, web, and customer support divisions, giving the requesting user (e.g., enterprise executive) visibility into aspects of the enterprise such as, for example, data quality, so that corrective action may be taken, for example. In at least one embodiment, incorrect or errored records may be marked to indicate that they were not corrected, and the reasons for such.

In particular, an error report may provide in numeric as well as graphical form, using tools such as charts 715 and 720, ranking or statistical analysis of the errors detected in a given set of enterprise application data or transactional data. For example, in at least one embodiment the enterprise business process management system 100 may perform analysis processes that provide information to the requesting user such as, but not limited to, a ranking of the data errors 720 detected for applications within different divisions 705, a traffic intensity indicator 710 for data transactions flowing into and out of a division 705, a productivity chart 715 showing the change in productivity for each division 705 over time, and a process error classification 725 of the strengths, weaknesses, costs, and gains associated with the data quality for the divisions 705.

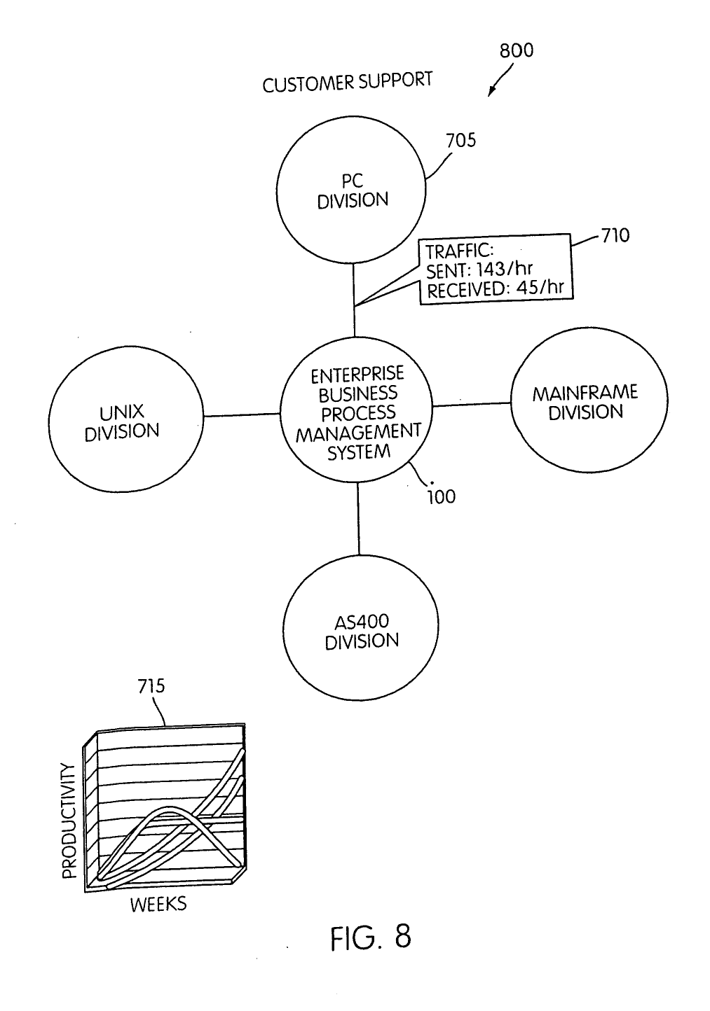

Similarly, FIGS. 8-10 are examples of an error report for a customer support view 800, an individual view 900, and a manager view 1000, respectively, according to at least one embodiment. Items including reference numbers identical to those appearing in FIG. 7 are as described earlier with respect thereto.

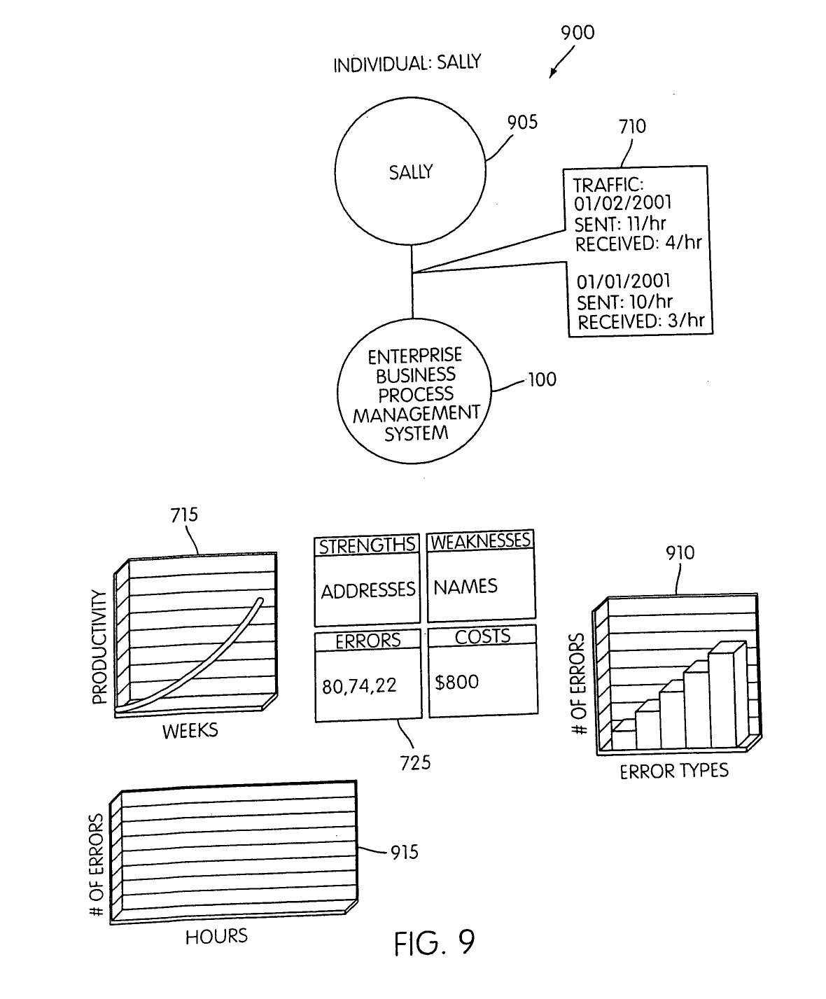

In particular, for individual view 900, the enterprise business process management system 100 may provide visibility to the requesting user into, for example, data errors attributable to a particular individual. For example, FIG. 9 shows a process error classification 725 of the strengths, weaknesses, costs, and gains associated with a particular individual 905, as well as the error types 910 committed by the individual 905 and the number of errors distributed over time 915 attributable to the individual 905. The example error classification 725 of the error report in FIG. 9 shows that the individual 905 is strong (i.e., few errors committed) in entering address information, is weak (i.e., many errors) in entering names, has committed 80, 74, and 22 errors in different time periods, and has cost the enterprise $800 as a result of the data errors.

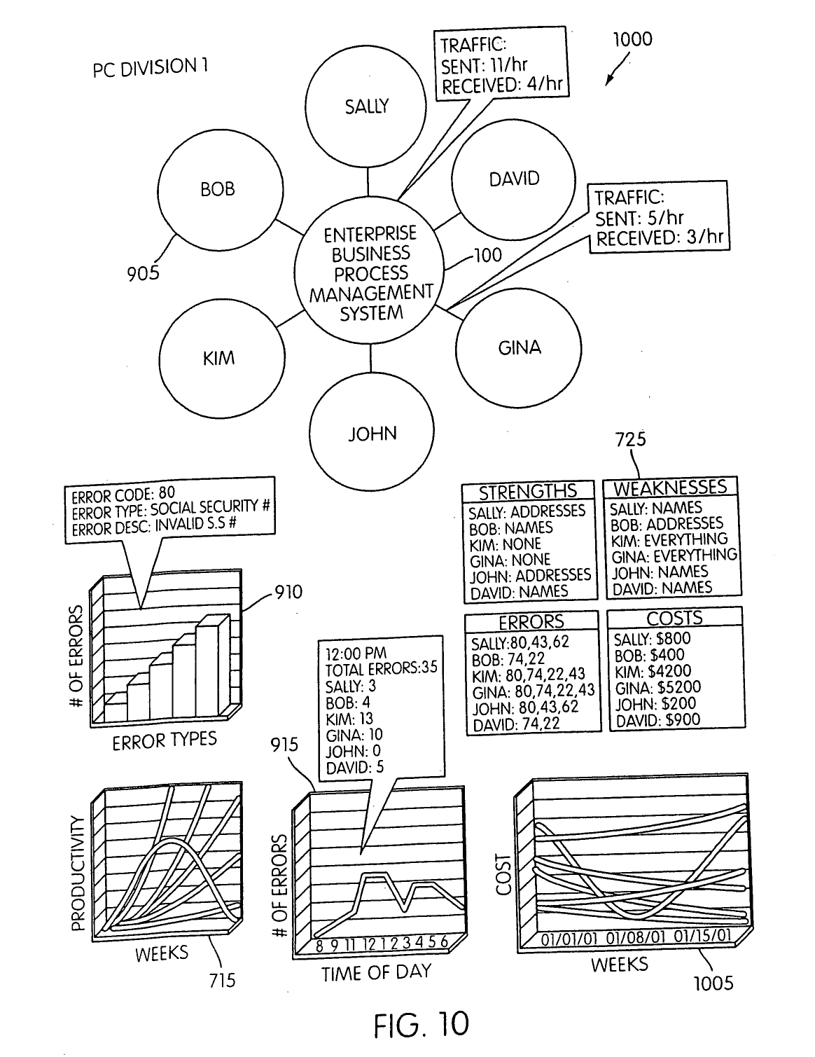

Furthermore, for manager view 1000, the enterprise business process management system 100 may provide visibility to the requesting user (e.g., enterprise manager) into data errors attributable to particular individuals 905 and to the individuals as a group. For example, FIG. 10 shows a process error classification 725 of the strengths, weaknesses, costs, and gains associated with multiple individuals 905, as well as the error types 910 committed by each of the individuals 905 and the number of errors distributed over time 915 (e.g., time of day) attributable to the group. A cost per time period chart 1005 may also be provided indicating the daily cost incurred by the enterprise for the data errors attributed to each individual 905.

In at least one embodiment, the enterprise business process management system 100 may provide the capability for a user (e.g., an administrative user) to create and establish business processes 310 for execution by the enterprise business process server 101. FIG. 11 is a flow chart of a method 1100 of establishing an exemplary data quality process for the enterprise business process management system 100 in accordance with at least one embodiment. The method 1100 may commence at 1105 upon the enterprise business process server 101 receiving a user request to create a process 310. A user may enter a request to create a process 310 by, for example, using a pointing device to select an associated hyperlink contained on an interactive page provided by a graphical user interface portion of the enterprise data quality application 300.

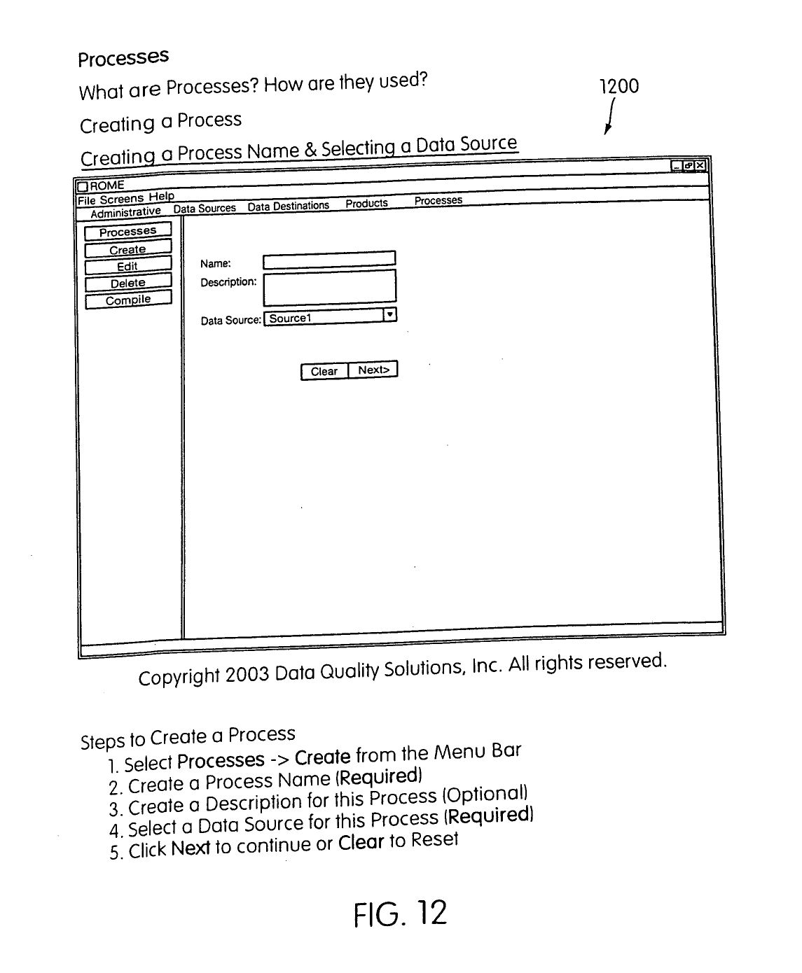

Control may then proceed to 1110, at which the enterprise business process server 101 may prompt the user to create a process name and select a data source for the process 310. FIG. 12 is an example of an interactive page 1200 provided by the enterprise business process server 101 in which a user may enter a process name, description, and associated data source 305.

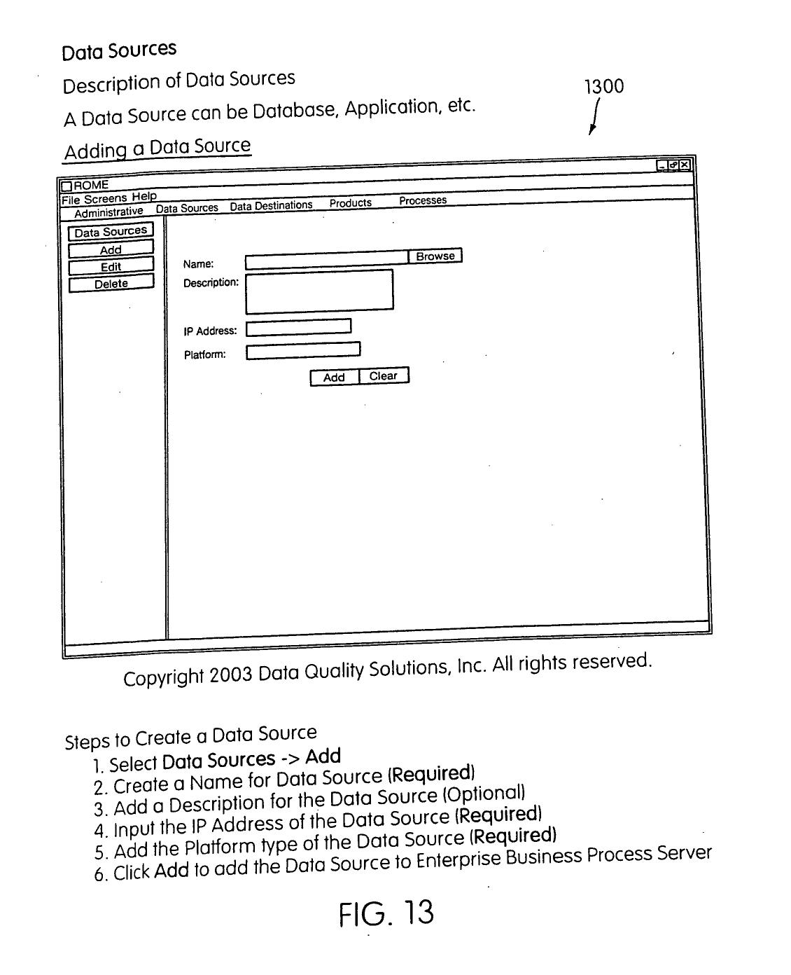

Control may then proceed to 1115, at which the enterprise business process server 101 may prompt the user to enter a new data source 305, if necessary. If the user responds by requesting to add a new data source 305, control may proceed to 1120 at which the enterprise business process server 101 may generate and output an interactive page 1300 for a user to add a data source 305. FIG. 13 is an example of an interactive page 1300 provided by the enterprise business process server 101 in which a user may add a data source 305 by entering information such as, but not limited to, a data source name, description, IP address, Port Number, and platform identifier.

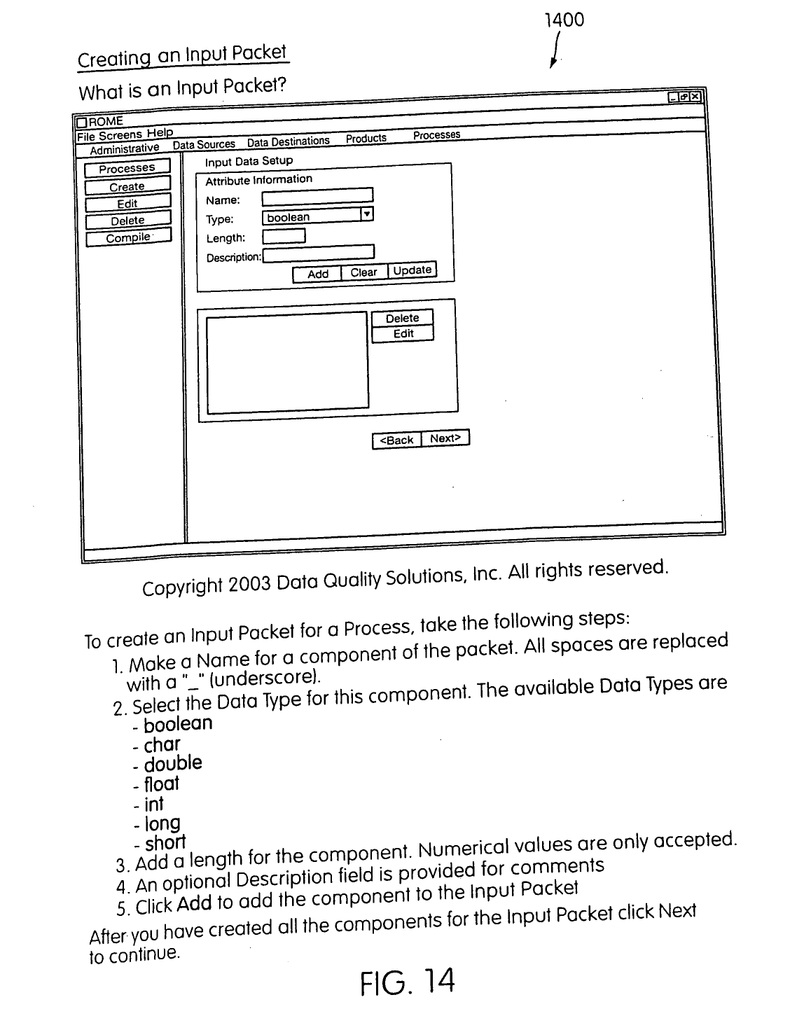

Control may then proceed to 1125, at which the enterprise business process server 101 may prompt the user to create an input packet for the process 310. FIG. 14 is an example of an interactive page 1400 provided by the enterprise business process server 101 in which a user may create an input packet by entering attribute information such as, but not limited to, an input element name, type, length, and description. The input element type may specify a data type for the input packet such as, but not limited to, boolean, character, double character, wide character (UNICODE), floating point decimal, integer, long integer, or short integer.

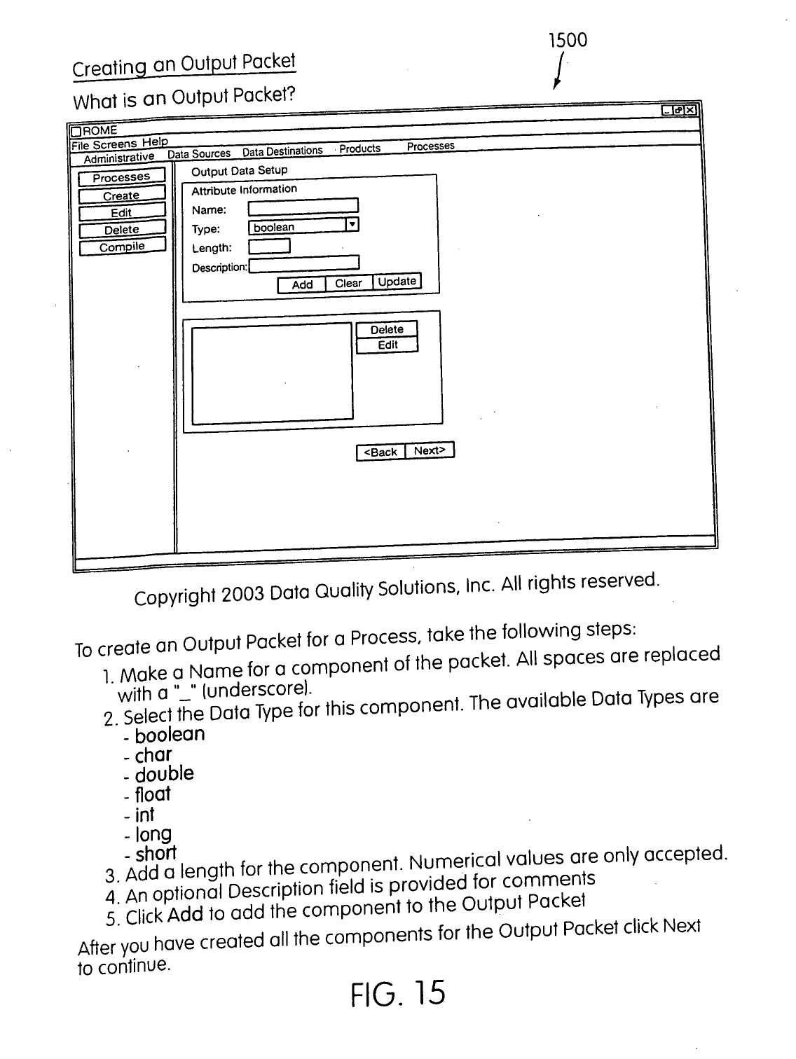

Control may then proceed to 1130, at which the enterprise business process server 101 may prompt the user to create an output packet for the process 310. FIG. 15 is an example of an interactive page 1500 provided by the enterprise business process server 101 in which a user may create an output packet by entering attribute information such as, but not limited to, an output element name, type, length, and description. The output element type may specify a data type for the output packet such as, but not limited to, boolean, character, double character, wide character (UNICODE), floating point decimal, integer, long integer, or short integer.

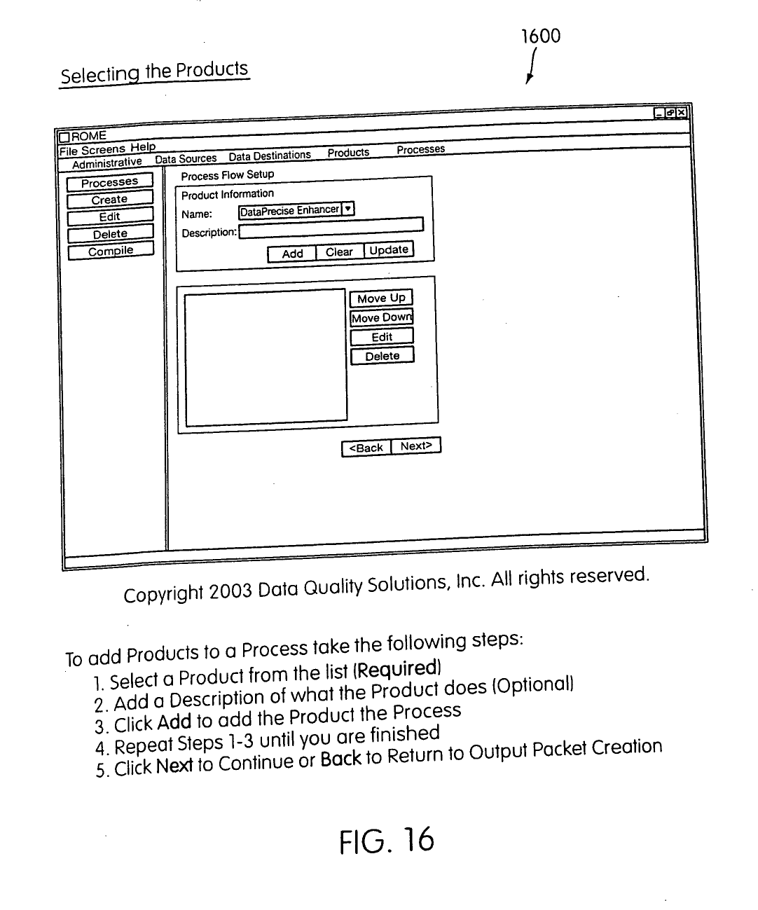

Control may then proceed to 1135, at which the enterprise business process server 101 may prompt the user to select a product 315 (or function or set of functions, as the case may be) to be associated with the process 310. A product 315 may include a function or a set of functions. FIG. 16 is an example of an interactive page 1600 provided by the enterprise business process server 101 using which a user may select a product 315 by entering, as a minimum, a selection of a product 315 from a pull-down list, for example, and a product description.

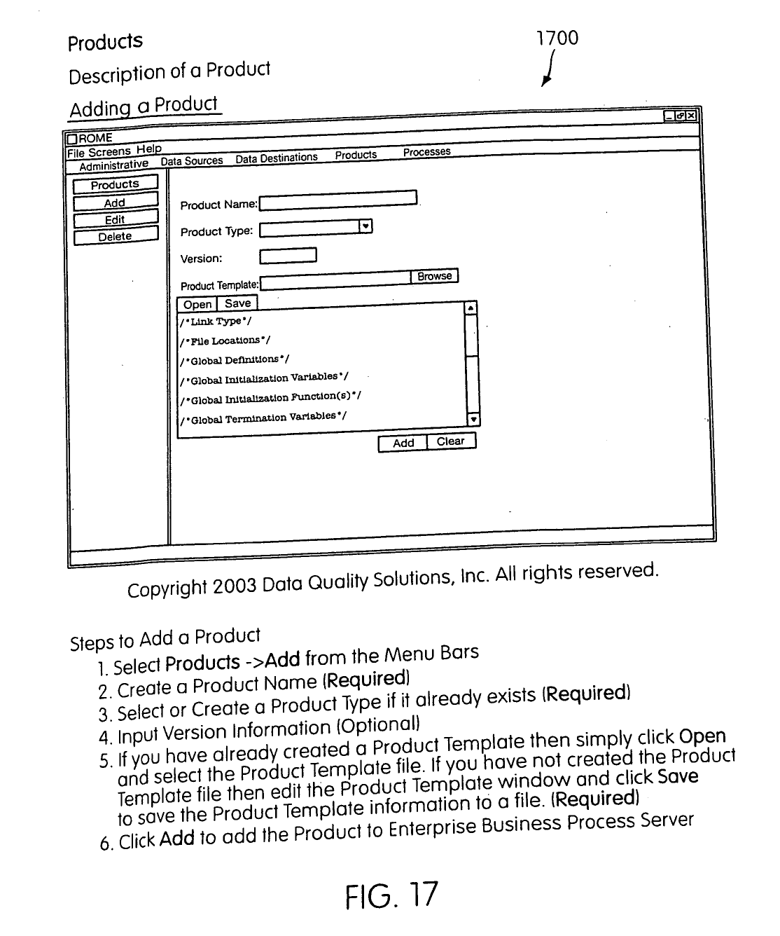

Control may then proceed to 1140, at which the enterprise business process server 101 may prompt the user to add a product 315, if necessary. If the user responds by requesting to add a product 315, control may proceed to 1145 at which the enterprise business process server 101 may generate and output an interactive page 1700 for a user to add a product 315. FIG. 17 is an example of an interactive page 1700 provided by the enterprise business process server 101 in which a user may add a product 315 by entering information such as, but not limited to, a product name, product type, version, and product template. APPENDIX A hereto provides an exemplary sequence of pseudocode instructions for creating a product template.

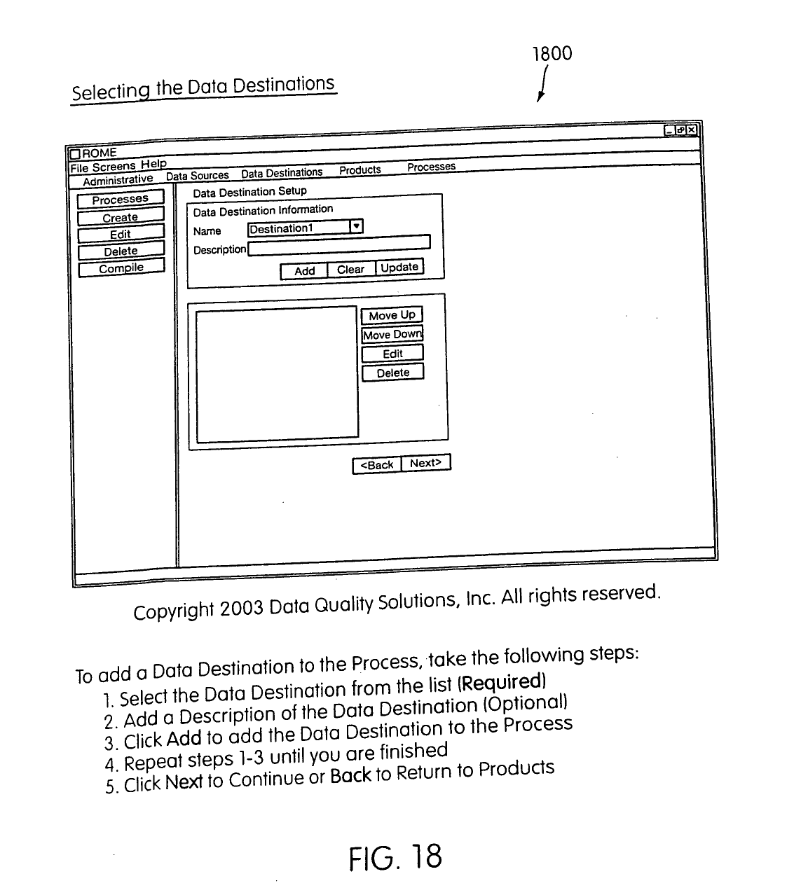

Control may then proceed to 1150, at which the enterprise business process server 101 may prompt the user to select a data destination 305 for the process 310. FIG. 18 is an example of an interactive page 1800 provided by the enterprise business process server 101 in which a user may enter a data destination name and description.

Control may then proceed to 1155, at which the enterprise business process server 101 may prompt the user to enter a new data destination 305, if necessary. If the user responds by requesting to add a new data destination 305, control may proceed to 1160 at which the enterprise business process server 101 may generate and output an interactive page (not shown) for a user to add a data destination 305 by entering information such as, but not limited to, a data destination name, IP address, Port Number, and description. In at least one embodiment, all or a portion of data output by the enterprise business process server 101 may go to one or more data destinations 305.

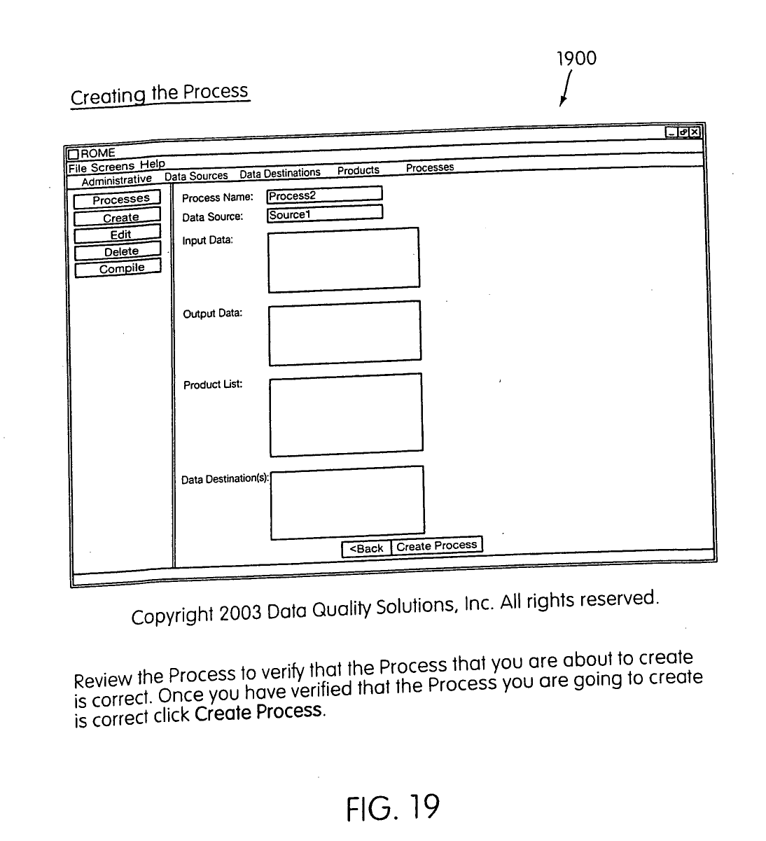

Control may then proceed to 1165, at which the enterprise business process server 101 may prompt the user to establish the process 310. FIG. 19 is an example of an interactive page 1900 provided by the enterprise business process server 101 in which a user may review and confirm information associated with the process 310 as described above. Summary process information provided by the page 1900 may include, but is not limited to, the process name, its data source 305, the input and output data specifications, the associated product 315 list, and the data destination(s) 305 for the process output. After a process 310 has been created, it may be edited (i.e., source code edit). Edited process instructions may be compiled into the process router. In at least one embodiment, the instructions may be source code instructions.

Processing for the method 1100 may end at 1170.

It should be noted that the data output from the system and method described may be provided in whole or in part to one or more destinations 305. In other words, all of the output data may be directed to a single destination 305. Alternatively, portions of the output data may be sent to multiple destinations 305.

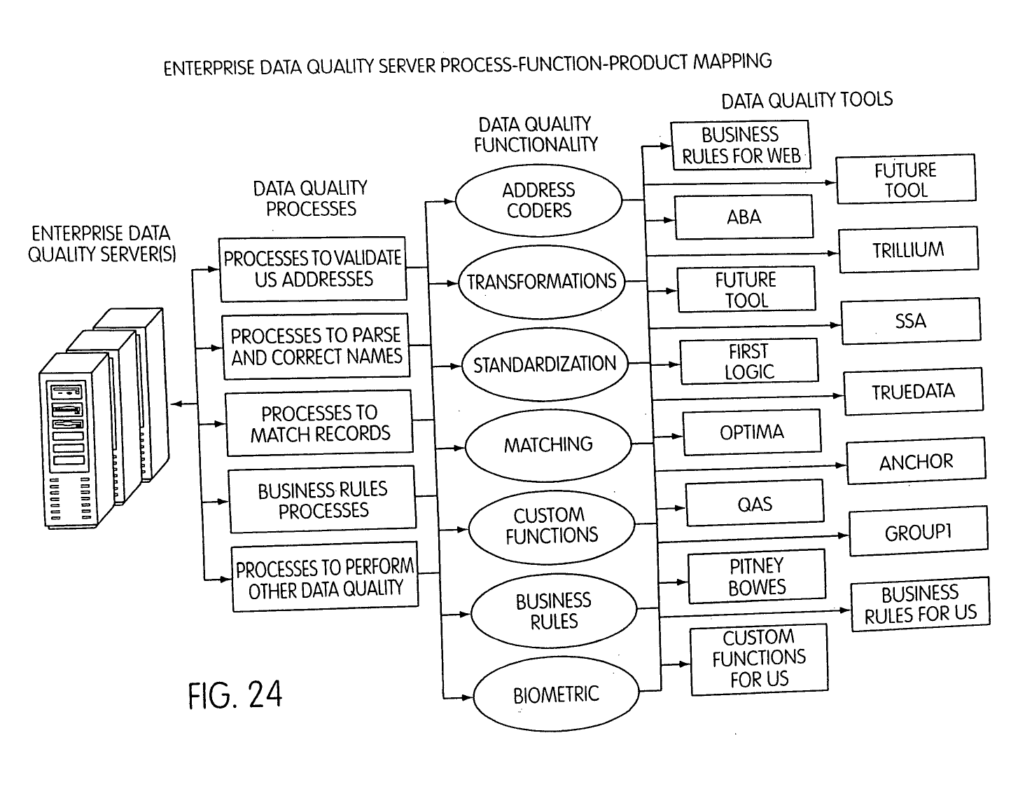

FIG. 24 provides a functional block diagram showing the relationship among functions, processes and products (e.g., tools) involved in the definition of data quality business processes in an embodiment.

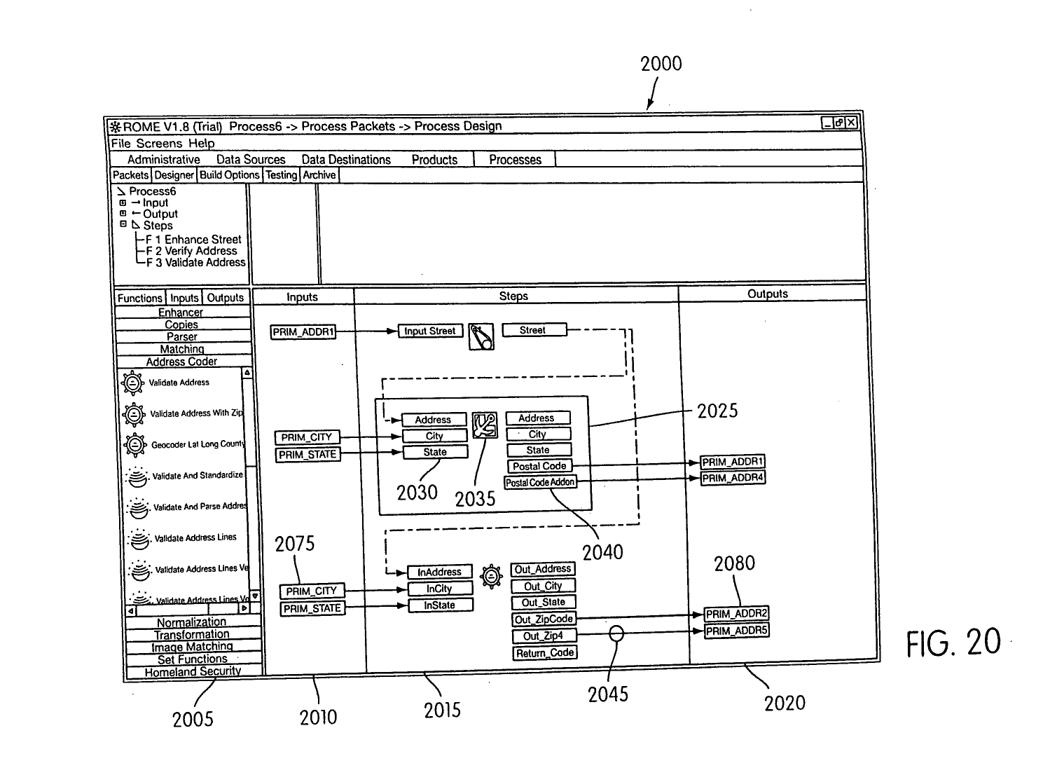

In at least one embodiment, the enterprise business process management system 100 may include an interface module, an example of which is described more particularly below. The interface module may also include aspects of the user interface described earlier herein. In an embodiment, the interface module 304 may be implemented as component of the enterprise data quality application 300 as shown in FIG. 3. The interface module may provide the capability for a user to define, create, modify, test and execute a sequence of function steps for a business process using the enterprise business process management system 100. In particular, the interface module may include an interactive graphically-oriented process specification tool that allows a user to define or modify a business process by, for example, selecting and moving (e.g., dragging and dropping) symbols relating to process functions to a display location representing a particular process step. Each process step may be represented, for example, as one or more function icons grouped together as shown generally in FIG. 20. FIG. 20 shows an example process designer interface interactive display 2000 provided in accordance with at least one embodiment. Thus, the interface module process designer may be used to define or specify a business process to be performed by the enterprise business process management system 100. As an overlay application to the developer's toolkit 303, the interface module 304 may provide interactive pages similar or in addition to FIGS. 12-19 described earlier herein.

A function may be a named section of a program that performs a specific task. In this sense, a function may be a type of procedure or routine. Some programming languages make a distinction between a function, which returns a value, and a procedure, which performs some operation but does not return a value. Most programming languages come with a prewritten set of functions that are kept in a library. Custom functions may also be developed that perform specialized tasks. For example, in the C language and certain other programming languages, a function is a named procedure that performs a distinct service. The language statement that requests the function is called a function call.

Referring to FIG. 20, the process designer interactive display 2000 may include a function library 2005, a process input area 2010, a process step definition area 2015, and a process output area 2020. Each process step 2025 may be represented, for example, as one or a group of function inputs 2030, function outputs 2040, and function identifiers 2035 within the process step definition area 2015. Each function input 2030 may be (or may not be) linked to an input element 2075 within the process input area 2010 using, for example, a link 2045. A link 2045 is also referred to as a connection or “road.” Similarly, the each function output 2040 may be (or may not be) linked to an output element 2080 within the process output area 2020 using, for example, a link 2045. In an embodiment, links 2045 may be used to represent the directional flow of information from source to destination such as, for example, from an input element 2075 to a function input 2030. The flow of information may be controlled by at least one router that uses packet header information and a routing table to determine the destination or target. Furthermore, process steps 2025 may be linked to form, for example, a chain of successive process steps 2025 to be sequentially accomplished in a business process.

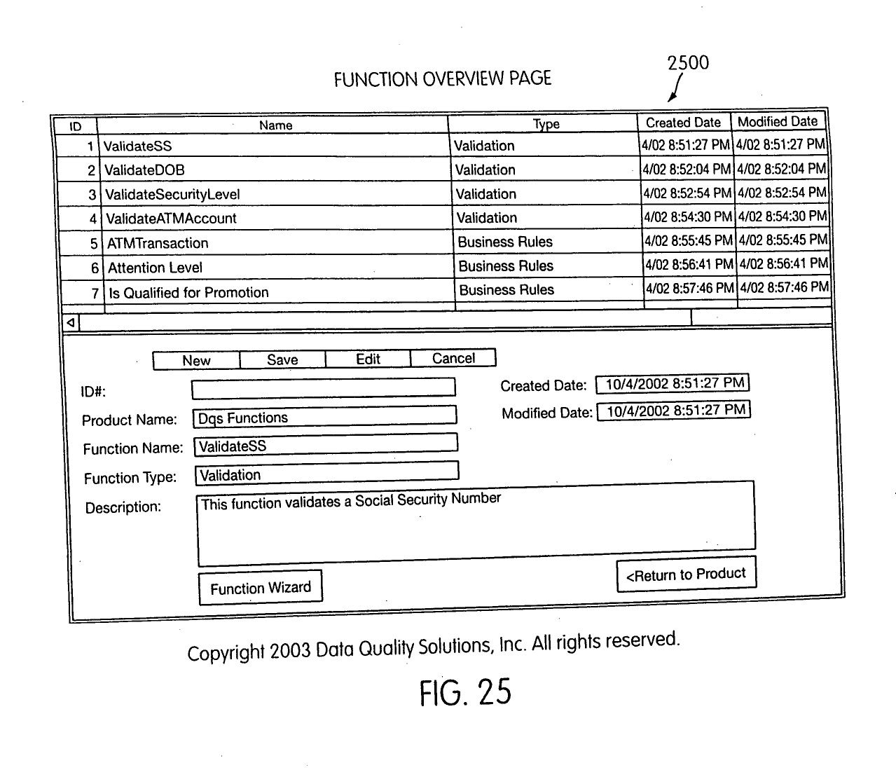

FIG. 25 shows an example of a functions overview interactive page provided in an embodiment. Referring to FIG. 25, a functions overview page 2500 may provide a listing of all functions currently included in the function library 2005. Functions therein may be ordered according to a variety of criteria such as, for example, chronologically by order of creation.

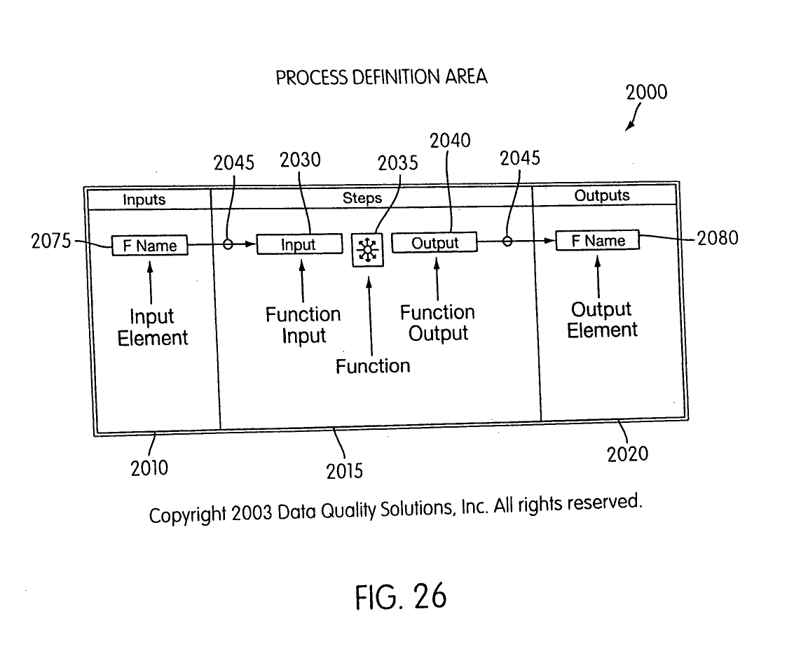

FIG. 26 shows an example of a process definition area portion of a process designer interactive page 2000 provided in an embodiment.

Each process step 2025 may represent a particular operation to be accomplished by the enterprise business process server when executing that process step 2025. In particular, a process step 2025 may include one or more function inputs 2030 and function outputs 2040. Furthermore, a function identifier 2035 may represent a particular operation to be performed using the function input(s) 2030 to produce the function output(s) 2040. In an embodiment, the enterprise business process management system 100 may perform many different process steps 2025 obtained from multiple application providers within a single business process. In at least one embodiment, the function identifier 2035 may serve to specify the functions and function elements of a particular application provider whose application(s) is used by the enterprise. Furthermore, multiple business processes may be supported by the enterprise business process management system 100.

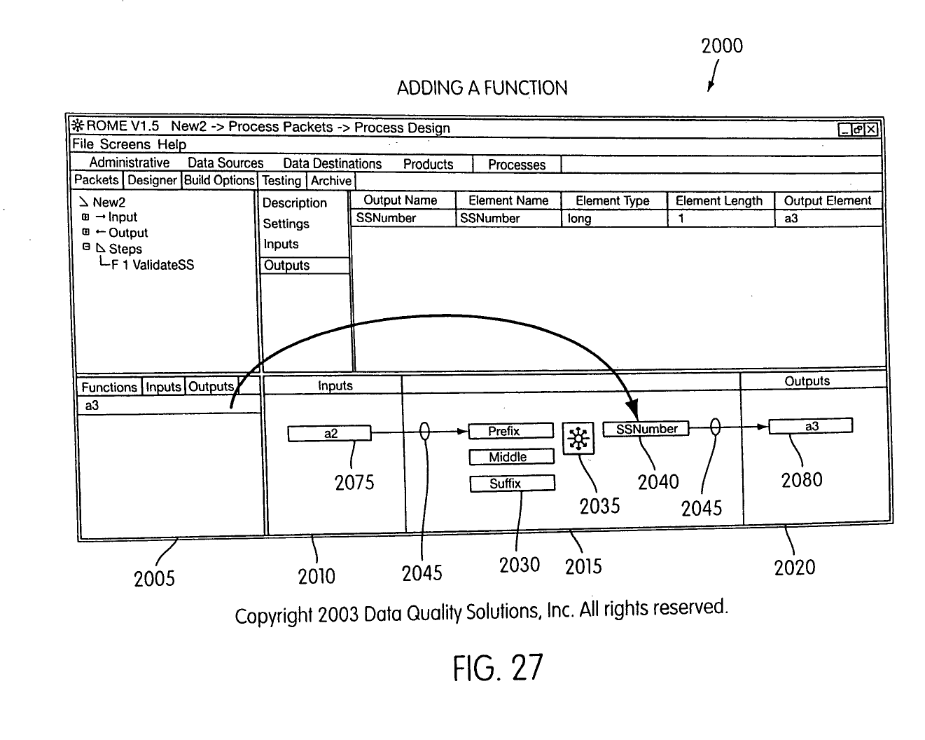

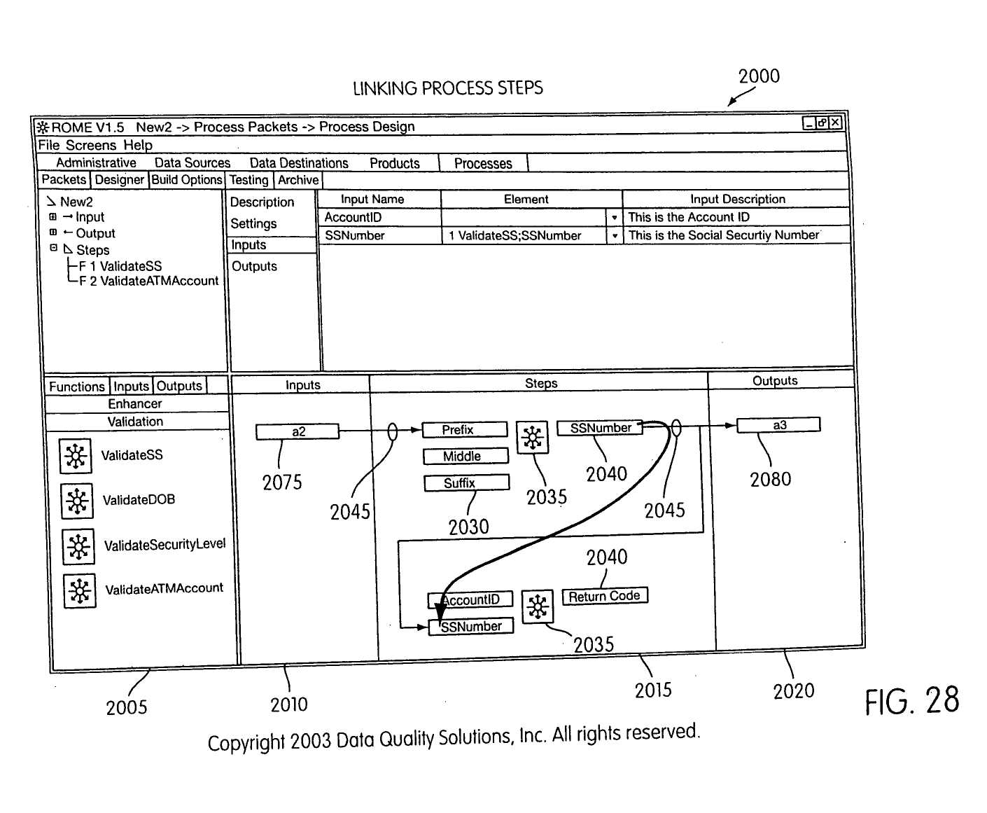

In at least one embodiment, a user of the enterprise business process management system 100 may interact with the process designer interactive display 2000 to create and modify process steps 2025 which make up a business process. In particular, the user may manipulate, move and link the display icons or symbols representing function inputs 2030, function outputs 2040, function identifiers 2035, input elements 2075, output elements 2080 and links 2045 using, for example, a pointing device of terminals 110-113. Alternatively, a keyboard device may be used for this purpose. For example, a new function input 2030 may be added to a process step 2025 by dragging and dropping (e.g., selecting) the new function input 2030 from the function library 2005 to the desired process step 2025 of the process step definition area 2015. FIG. 27 shows an example interactive page of the process designer 2000 illustrating adding an element of a process step 2025 from the function library 2005 in an embodiment. If the new function input 2030 requires an input element 2075, then the user may, for example, drag and drop the desired input element 2075 from the function library 2005 to the input area 2010 and add a link 2045 from the new input element 2075 to the new function input 2030. FIG. 28 shows an example interactive page of the process designer 2000 illustrating linking of process steps 2025 in the process definition area of a process designer interactive page in an embodiment.

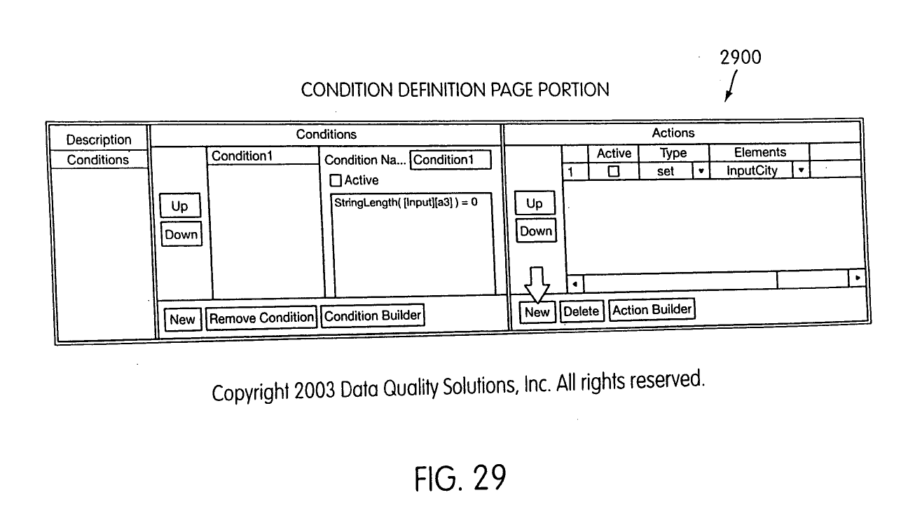

In an embodiment, a function input 2030 may include a conditional statement to specify alternative actions to be taken upon the occurrence (or not) of a specified event. FIG. 29 shows an example interactive page portion 2900 by which a conditional statement may be defined for an element of a process step according to at least one embodiment.

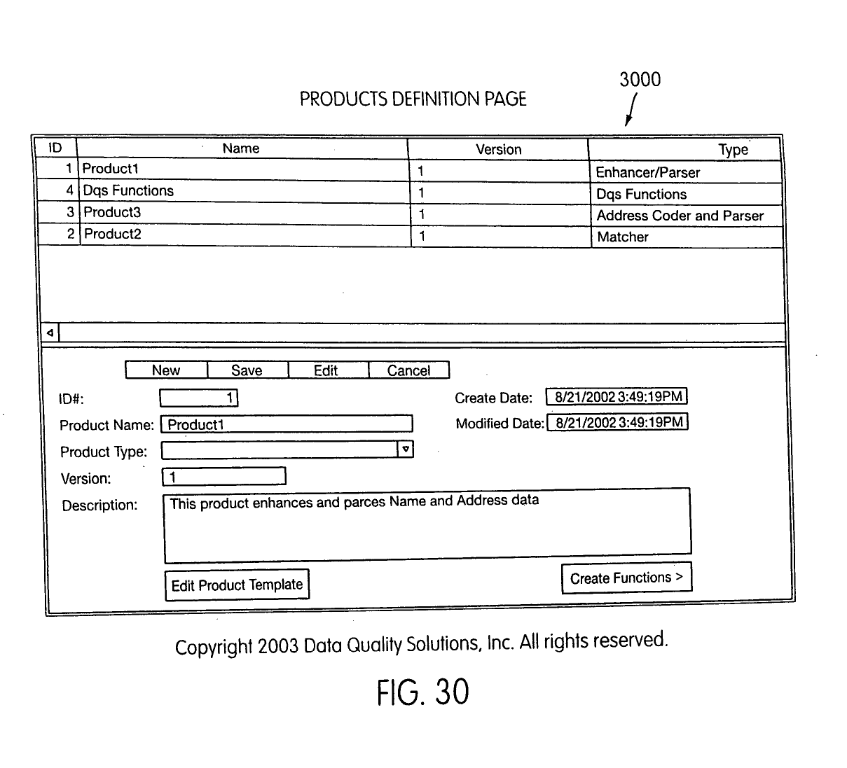

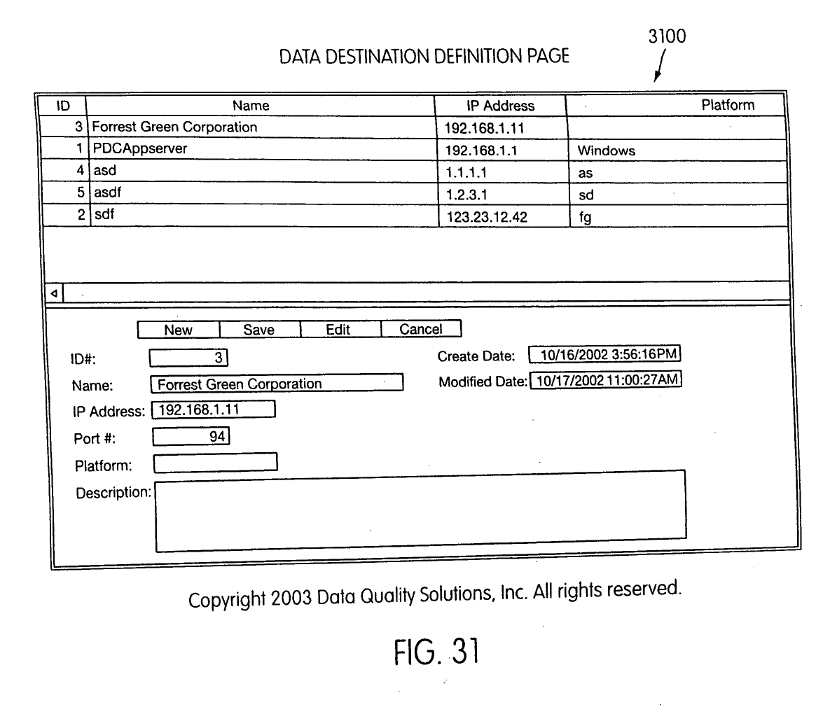

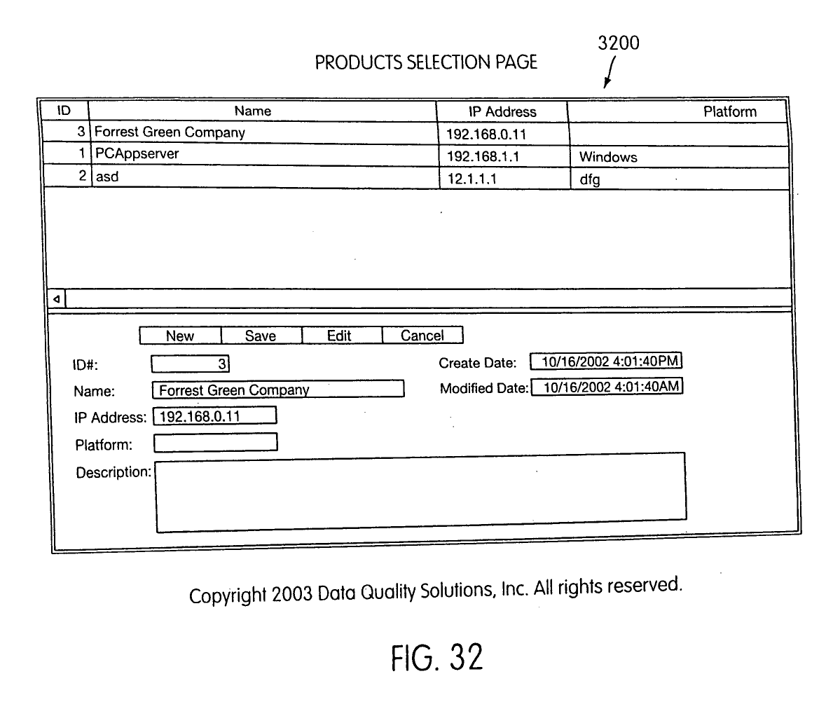

FIG. 30 shows an example of a products definition interactive page 3000 provided in an embodiment similar to FIG. 17. FIG. 31 shows an example of a data destination definition interactive page 3100 provided in an embodiment similar to FIG. 18. FIG. 32 shows an example of a products selection interactive page 3200 provided in an embodiment similar to FIG. 16.

In at least one embodiment, the enterprise business process management system 100 may retrieve, build and compile from a data store such as, for example, the data store 106, a sequence of instructions implementing the business process defined by the interface module process designer. In an embodiment, the interface module 304 of the enterprise business process server 101 may obtain a sequence of instructions implementing one or more business processes defined using, for example, the interface module, from the data store 106 for execution by the enterprise business process server 101.

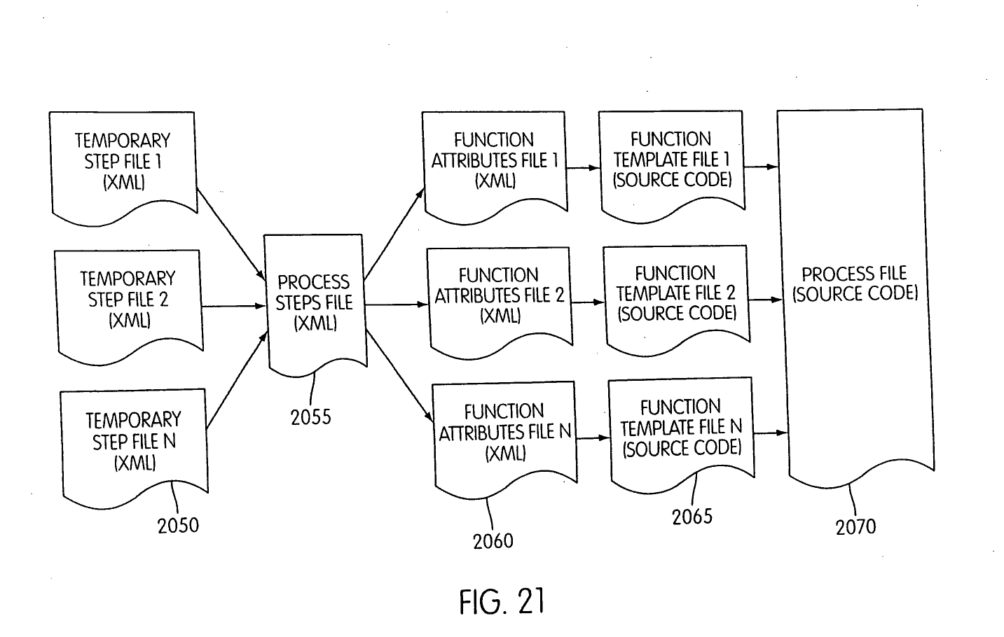

In at least one embodiment, the interface module 304 may assemble (i.e., build) a sequence of instructions implementing the interface module process designer defined process steps 2025 in a series of build steps utilizing a number of build files. FIG. 21 shows a series of build files utilized in an embodiment by the enterprise business process server to build a code implementation of a business process. Referring to FIG. 21, a set of build files for a business process may, in an embodiment, include at least one temporary step build file(s) 2050, a process steps file 2055, one or more function attributes file(s) 2060, one or more associated function temporary files(s) 2065, and a process file 2070. The enterprise business process management system 100 may use these files in an embodiment to implement a business process defined by a business analyst, for example, using the interface module process designer in the following manner.

In an embodiment, all functions that have been added to the enterprise business process management system may appear in the function library 2005 (FIG. 20). Each function may be identified in the function library 2005 by a function name and an icon, for example. The function attributes file 2060 may contain all of the necessary information, in XML format, for example, so that when this function is added as a step in a process the function will be displayed on the interface module process designer 2000 with the correct number of function inputs 2030, function outputs 2040, and will have the associated settings defined by the content parameters of data fields used by or produced by the function. In an embodiment, every function in the enterprise business process management system 100 has its own function attributes file 2060. Function step 2025 shows an example of a function as is appears using the interface module process designer 2000 when added as a step to a business process. When a function is added to the business process, the interface module 304 first reads the function attributes file 2060 for that function. After reading the function attributes file 2060, the interface module 304 builds the necessary input and output elements for that function as they are defined in the function attributes file 2060.

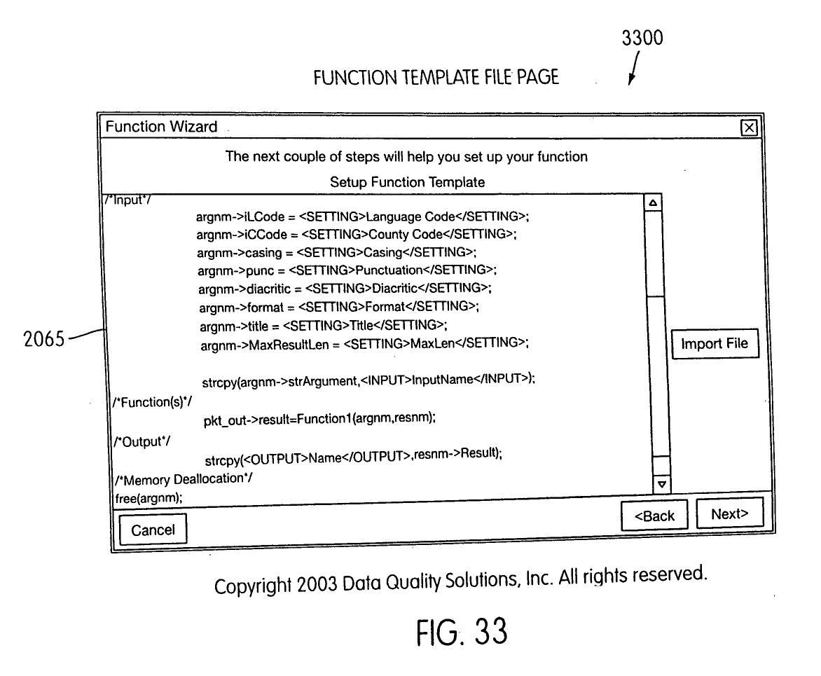

In an embodiment, the interface module 304 may include a function wizard that provides a sequence of interactive pages to the user operable to assist the user in importing a pre-built function into the library or modifying an existing function. The function wizard may include interactive fields of one or more interactive pages in which a user may enter a function name, choose a function icon, enter an associated product name, enter a function type, and add a function description. The function wizard may provide a function template in response to the user entered information. Function templates may be maintained using, for example, the function template files 2065. The function template may include a sequence of instructions that define various aspects of the function (e.g., variables). The actual values for each function variable may be determined by a function setting that corresponds to each function variable. FIG. 33 shows an example of the content of a function template file page 3300 provided in an embodiment.

After the function has been added to the business process, a temporary step file 2050 may be created. In an embodiment, the temporary step file 2050 may be provided in XML format. The temporary step file 2050 may contain all of the information about the function as it pertains to this step in the business process. It is important to note that the temporary steps file may be different for every step, even if it is from the same function.

Furthermore, as illustrated in FIG. 21, the interface module 304 may create the process steps file 2055 when the business process is to be built. In an embodiment, the process steps file 2055 may be the joined group of temporary step file(s) 2050 associated with this business process.

Finally, the interface module 304 may create the process instruction set file 2070 as follows. First, the interface module 304 may read the process steps file 2055. Since each step in may correspond to a function in the function library, the interface module may retrieve the function attributes file 2060 for each step in the process steps file 2055, and then map the data in the process steps file 2055 to the corresponding fields in the function attributes file 2060. Next, after the information from the process steps file 2055 has been linked to corresponding fields in the function attributes file 2055, the interface module 304 may then map each function attributes file 2060 to a function template file 2065. The function template file 2065 may, in an embodiment, contain source code instructions (e.g., ‘C’ source code) to be added to the sequence of instructions implementing the process. Furthermore, in at least one embodiment, the function template file 2065 may include XML tags that correspond to fields in the associated function attributes file 2060. As the function template file source code is being added to the source code in the process instruction set file 2070, the interface module 304 may replace the XML tags in the function template file 2065 with the data that was provided in the function attributes file 2060 which was in turn the data that was provided from the process steps file 2055.

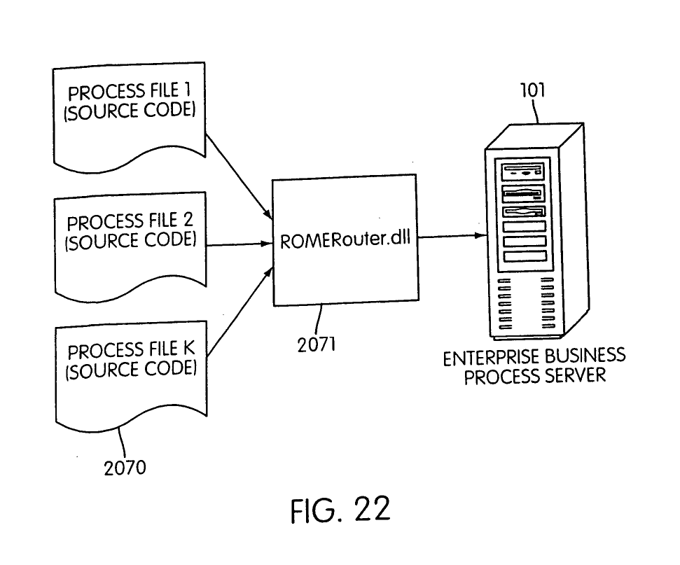

In an embodiment, following build of a new process instruction set file 2070, the enterprise data quality application 300 may build a new router DLL including the new process source code file 2070 as shown in FIG. 22. In at least one embodiment, the instruction set file 2070 may include source code instructions. Referring to FIG. 22, the enterprise data quality application 300 may build a new router DLL 2071 including the new process instruction set file 2070 (e.g, Process File 1) along with other process instruction set files (e.g., Process Files 2-K). The new router DLL 2071 may then be loaded by the enterprise business process server 101 and placed into service, at which point the new process may be executed.

FIGS. 23a-d provide a flow chart illustrating more particularly a method of implementing a business process in accordance with at least one embodiment. Referring to FIG. 23, a method may commence at 2300 and proceed to 2302. At 2302, a user may send a request to the enterprise business process server 101 to create or modify a business process. In an embodiment, the user request may be output by the terminal 110, 111, 112 or 113 to the enterprise business process server 101 using a network such as, for example, a packet-based network. An example of a packet-based network is the Internet. The user may be a business analyst, for example. In an embodiment, the request may be provided as an XML-formatted request. In response, the enterprise business process server 101 may output to the requesting terminal 110, 111, 112 or 113 an interactive page such as, for example, the interface module process designer interactive display 2000. In an embodiment, the interface module process designer interactive display 2000 may be provided in the form of an XML-formatted interactive page suitable for display at the terminal using a web browser application of the terminal.

Control may then proceed to 2304, at which the user may desire to add a process step to or modify a process step of the business process (reference FIG. 20). Control may then proceed to 2306, at which the user may determine that a function to be added to a process step, or for which a new process step is to be added, may need to be added to the function library. If so control may proceed to 2308. If not, control may proceed to 2312.

At 2308, the user may enter information defining a new function into the function library. Such information may include, but is not limited to, a function name and a function icon. The function name may provide a brief description of the operation provided by the function. The function icon may be a symbol representing the vendor or provider of the application from which the function is taken. In an embodiment, all functions used in process steps must be included in the function library.

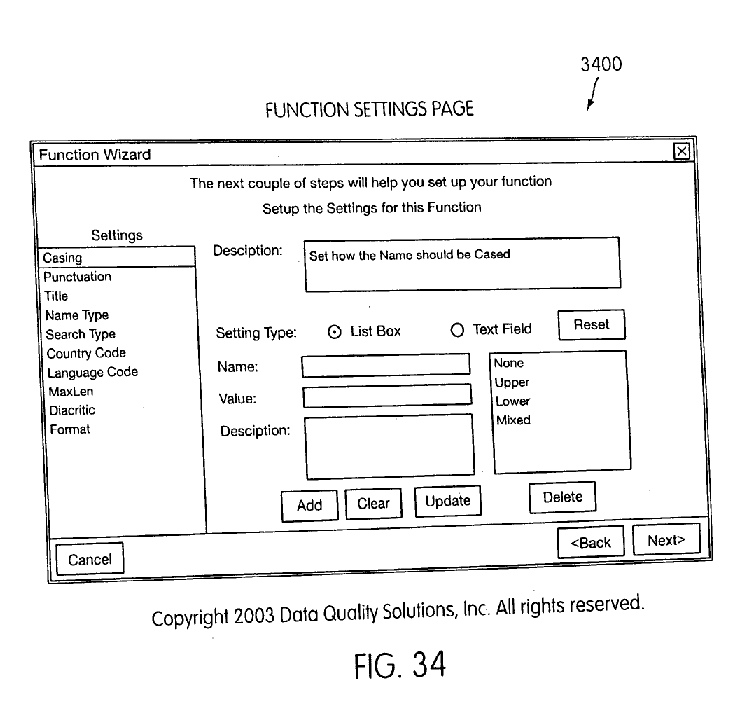

Control may then proceed to 2310, at which the user may define particular function attributes using the function attributes file. The function attributes file may include all information necessary to define a function information, in XML format, so that when this function is added as a step in a business process the function will be displayed on the interface module process designer with the correct number of function inputs and function outputs, as well as its associated function settings. In an embodiment, the function attributes file may be provided in accordance with the XML format. Also in an embodiment, every function in the function library may have an corresponding function attributes file. FIG. 34 shows an example of a function settings interactive page 3400 provided in an embodiment.

Control may then proceed to 2312, at which a temporary step file may be created as follows. When a function is added to the business process, the interface module may first read the function attributes file for that function. After reading the function attributes file, the interface module may build the necessary input and output elements for that function as they are defined in the function attributes file. In an embodiment, the temporary step file may be provided in XML format. The temporary step file may contain all of the information about the function as it pertains to this step in the business process. It is important to note that the temporary steps file may be different for every step, even if it is from the same function.

Control may then proceed to 2314, at which the interface module may create the process steps file. In an embodiment, the process steps file may be the joined or assembled group of temporary step file(s) associated with this business process.

Control may then proceed to 2316, at which the interface module may retrieve the function attributes file for each step in the process steps file. Control may then proceed to 2318, at which the interface module may map the data in the process steps file to the corresponding fields in the function attributes file. Control may then proceed to 2320, at which the interface module may map each function attributes file to a function template file. The function template file may, in an embodiment, contain source code instructions (e.g., ‘C’ source code) to be added to the sequence of instructions implementing the process. Furthermore, in at least one embodiment, the function template file may include XML tags that correspond to fields in the associated function attributes file.

Control may then proceed to 2322, at which the interface module may replace the XML tags in the function template file with the data that was provided in the function attributes file, which was in turn the data that was provided from the process steps file.

Control may then proceed to 2324, at which the interface module may assemble the data-populated function template files into a process instruction set file containing a sequence of program instructions implementing the process. Control may then proceed to 2326, at which the interface module may store the process instruction set file in a data store. The instruction set file may be, but is not limited to, a source code file.

Control may then proceed to 2328, at which the enterprise data quality application core application may determine if the user has specified the business process to be a test process or a production process. In an embodiment, the business analyst module 304 may provide an interactive page (not shown) for the user to specify whether a test build or a production build of the router is to be performed. If a test process, control may proceed to 2330 at FIG. 23c. If a production process, control may proceed to 2350 at FIG. 23d.

At 2330 of FIG. 23c, at which following the build of a new test process instruction set file, the enterprise data quality application core application may build a new router DLL including the new test process instruction set file (see FIG. 22). The test process instruction set may be optimized for production.

Control may then proceed to 2332, at which the interface module may notify the enterprise business process server that a new router is ready to be loaded. Control may then proceed to 2334, at which the enterprise business process server may pause and halt any transactions from entering the current router, allow all transactions currently in the router to finish processing, and unload the current router.

Control may then proceed to 2336, at which the enterprise business process server may notify the interface module that the current router has been unloaded.

Control may then proceed to 2338, at which, upon receiving notification that the current router has been unloaded, the interface module may archive the current (i.e., “old”) router, replace it with the newly built router, and notify the enterprise business process server to load the new router.

Control may then proceed to 2340, at which the enterprise business process server may load and initialize the new router and allow transactions to enter the new router.

Control may then proceed to 2342, at which the enterprise business process server may notify the interface module that the new router has been loaded.

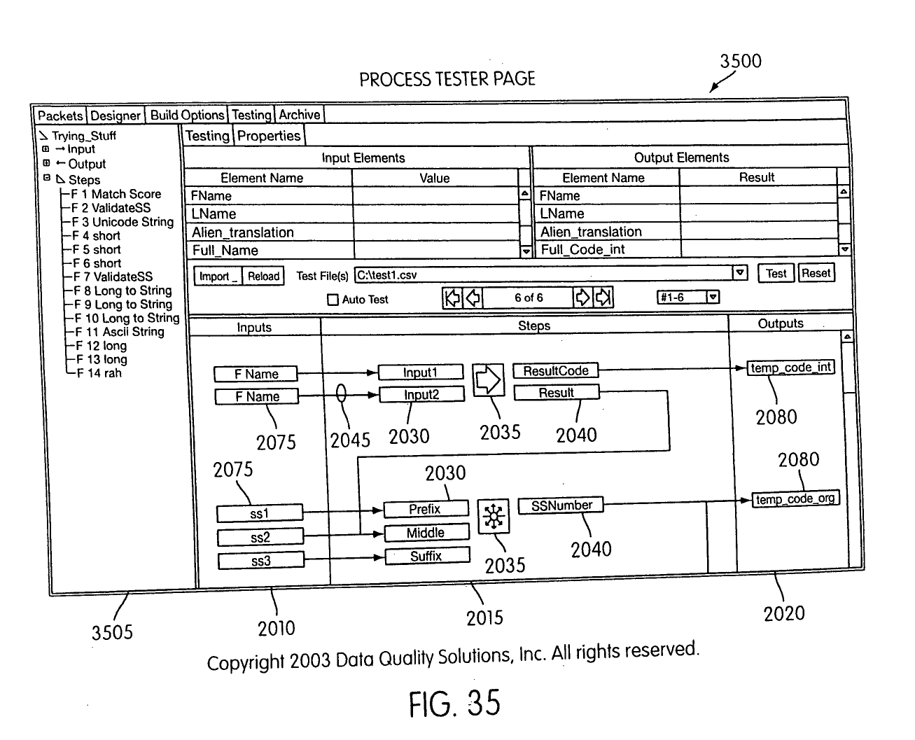

Control may then proceed to 2344, at which, upon receiving notification that the new router has been loaded, the interface module may output to the terminal of the user a process tester interactive page. FIG. 35 shows an example process tester interactive page 3500 according to an embodiment. A process tester interactive page 3500 may include a process test steps listing 3505.

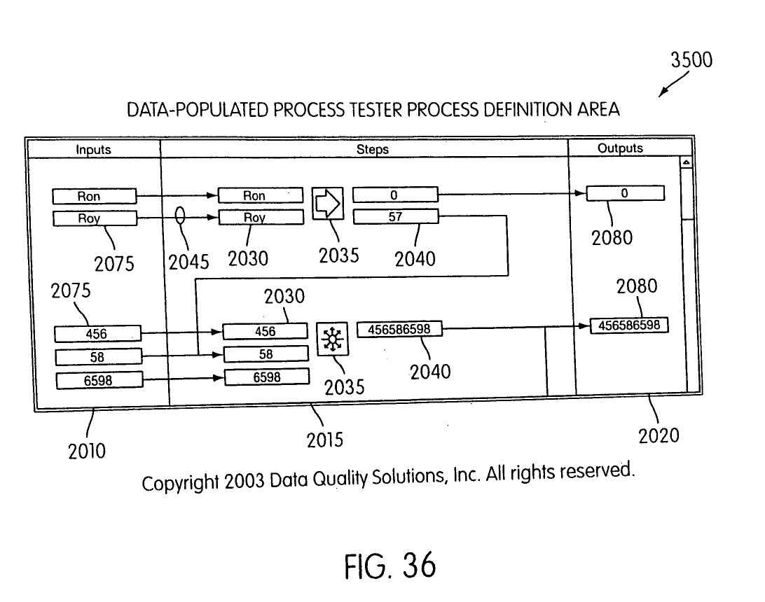

Control may then proceed to 2346, at which the terminal may output the process tester interactive page to the user via, for example, a display of a web browser application. FIG. 36 shows an illustration of a data-populated process definition area of a process tester interactive page 3500 in an embodiment in which the interface module has replaced the XML tags in the function template file with the data that was provided in the function attributes file.

Control may then proceed to 2348, at which a method may end.

At 2350 of FIG. 23d, at which following the build of a new production process instruction set file, the enterprise data quality application core application may build a new router DLL including the new production process instruction set file (see FIG. 22). The production process instruction set may be optimized for production.

Control may then proceed to 2352, at which the interface module may notify the enterprise business process server that a new router is ready to be loaded. Control may then proceed to 2354, at which the enterprise business process server may pause and halt any transactions from entering the current router, allow all transactions currently in the router to finish processing, and unload the current router.

Control may then proceed to 2356, at which the enterprise business process server may notify the interface module that the current router has been unloaded.

Control may then proceed to 2358, at which, upon receiving notification that the current router has been unloaded, the interface module may archive the current (i.e., “old”) router, replace it with the newly built router, and notify the enterprise business process server to load the new router.

Control may then proceed to 2360, at which the enterprise business process server may load and initialize the new router and allow transactions to enter the new router.

Control may then proceed to 2362, at which the enterprise business process server may notify the interface module that the current router has been unloaded.

Control may then proceed to 2364, at which, upon receiving notification that the new router has been loaded, the interface module may output to the terminal of the user a main processes interactive page.

Control may then proceed to 2366, at which the terminal may output the main processes interactive page to the user via, for example, a display of a web browser application.

Control may then proceed to 2368, at which a method may end.

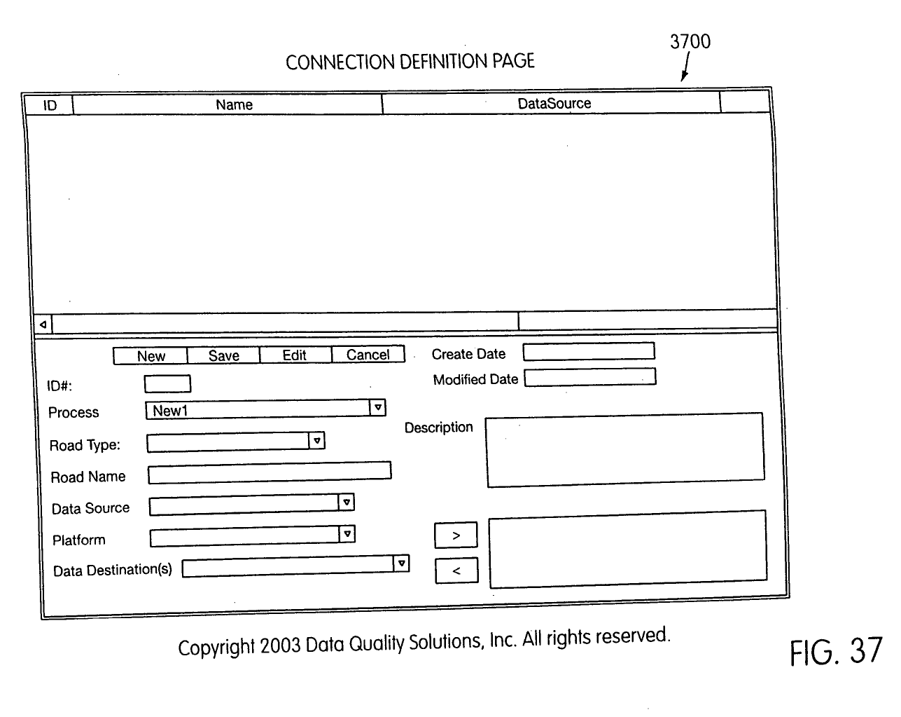

In at least one embodiment, the enterprise business process server 101 may retrieve and execute a particular business process upon receiving a packet of input elements associated with that business process from a data source via a connection. In at least one embodiment, such a connection may be a compiled dynamic link library (DLL) file that maps the business application function input data and output data to corresponding information fields of functions of an associated business process. FIG. 37 shows an example of a connection definition interactive page 3700 by which a user may define a connection according to at least one embodiment. Each enterprise application may have a corresponding connection maintained using the data store 106, for example, that maps its functions to one or more business processes executed by the enterprise business process server 101. Upon receiving an associated packet of input elements, the enterprise business process server 101 may retrieve and execute the associated business process and produce its resultant output elements. In an embodiment, the enterprise business process server 101 may send a packet containing the output elements to a data destination via the connection for further processing. A connection may encapsulate data routing information specifying the path between to enterprise nodes. In an embodiment, the connection may be a socket connection for a packet-based network such as, for example, TCP/IP.

Thus, an interface module may provide the capability for a user, such as a business analyst for example, to define, create, modify, implement, test and execute a business process using the enterprise business process management system without having to undertake a lengthy requirements definition, general design, detailed design, coding and testing cycle involving software engineering or programming personnel. The interface module of the enterprise business process management system as shown herein allows rapid iterative development and implementation of business processes, reducing development costs and time, as well as reducing the need to periodically freeze functional requirements.

Thus, an enterprise business process management system has been described, embodiments of which may provide an integrated data quality management system capable of collecting, analyzing, and reporting information concerning qualitative and quantitative aspects of application or transactional data throughout an enterprise. It should be understood that the enterprise data quality management system described herein is but one aspect of the enterprise business process management system of the present invention. One skilled in the art would be capable of determining other embodiments of the present invention based on the disclosure herein. In particular, the enterprise business process server 101 may be more generally described as a server capable of providing or operating in conjunction with many different enterprise business process applications. In general, such an enterprise business process management system may provide the capability to collect, analyze, and report information concerning qualitative and quantitative aspects of application or transactional data throughout an enterprise across some or all of the computing nodes of the entire enterprise network, and is able to process application data output by heterogeneous computing platforms and applications. As a result, the enterprise business process management system may provide a variety of integrated views of data present throughout the enterprise. Such views may range from data associated with the total enterprise, to individual divisions or business functions/business units, down to individuals.

For example, an embodiment of the enterprise business process management system may be directed to biometric and homeland security applications such as, but not limited to, defining, building and executing business processes that include functions from business applications involving fingerprint analysis, retinal imaging/scanning, voice identification, and image matching and comparison. In a particular example of such a business process, an employee of a company may be required to pass a fingerprint identification scan in order to enter a company facility. When the employee places their fingerprint on a fingerprint pad or scanner, data representing the unique fingerprint scan may be sent to a process maintained by the enterprise business process management system. This process may include, for example, comparing the scanned fingerprint data to a set of valid fingerprints using one or more functions from different fingerprint software matching tools that attempt to validate the employee against the company employee fingerprint database. If the employee is validated as an employee then a signal may be sent from the enterprise business process management system to an access control device of the door so that the door will unlock and allow the employee ingress access.

In another example of such a business process, photographic imaging data may be input to a multiple step business process that attempts to match the photographic imaging data against multiple image databases to search for matching features. If a match is found, then a signal may be sent to another process maintained by the enterprise business process management system to output the image coordinates to a targeting or reporting system.

In another example, an embodiment of the enterprise business process management system may be directed to compliance assurance such as, for example, business compliance with applicable governmental regulations. Such applications are myriad. One example in particular may be a business process directed to ensuring that a healthcare enterprise operates in conformance with government mandated rules and regulations such as, for example, the Health Insurance Portability and Accountability Act of 1996 (“HIPAA”). In a particular example of such a business process, business rules applying HIPAA requirements may be maintained in the function library, and a business process defined and executed that includes a series of business rules that must be applied to particular patient information based upon government HIPAA requirements. In an embodiment, this process may be a multiple step process with each step representing a different HIPAA requirement. This arrangement may provide for easy modification of such rules based upon changing government requirements. In other words, after the roads to the business applications for HIPAA compliance have been established, the corresponding functions used to represent the requirements as process steps may be modified as described herein using, for example, the interface module process designer. In this way, new changes to regulations affecting a business may be accommodated with minimal impact to the business process.

As another example, an embodiment of the enterprise business process management system may be directed to ensuring that government data quality regulations are met for a data set. For example, data concerning child welfare provided to the federal government may be required to comply to a specified data accuracy, such as greater than 90% accuracy.

As another example, an embodiment of the enterprise business process management system may be directed to tax assignment applications such as, but not limited to, defining, building and executing business processes that include functions from business applications involving geographic coding software and tax assignment software. In a particular example of such a business process, an organization may need to correctly assign the appropriate tax to their client's bills during the billing process. Incorrect tax assignment during the billing process may result in lost customers. Therefore, in an embodiment, a business process may be created and executed (or, alternatively, a sequence of process steps in a billing process) in which customer information, such as address information, is checked for accuracy by multiple functions from different tax assignment business applications (e.g., software packages) prior to final processing and mailing of bills to customers. The results of the functions may then, for example, be compared against each other and based on those results a correct tax could then be assigned. Furthermore, after the correct tax is determined, the correct tax assignment and the customer identifier may be sent as input into another business process which may, for example, receive as input a tax assignment and a customer identifier, and then perform multiple steps in which each step would perform an SQL query against different databases. In an embodiment, each step may perform a data store lookup of the customer via the customer identifier and then update that customer's tax assignment so that the customer has the same tax assignment across multiple data stores.

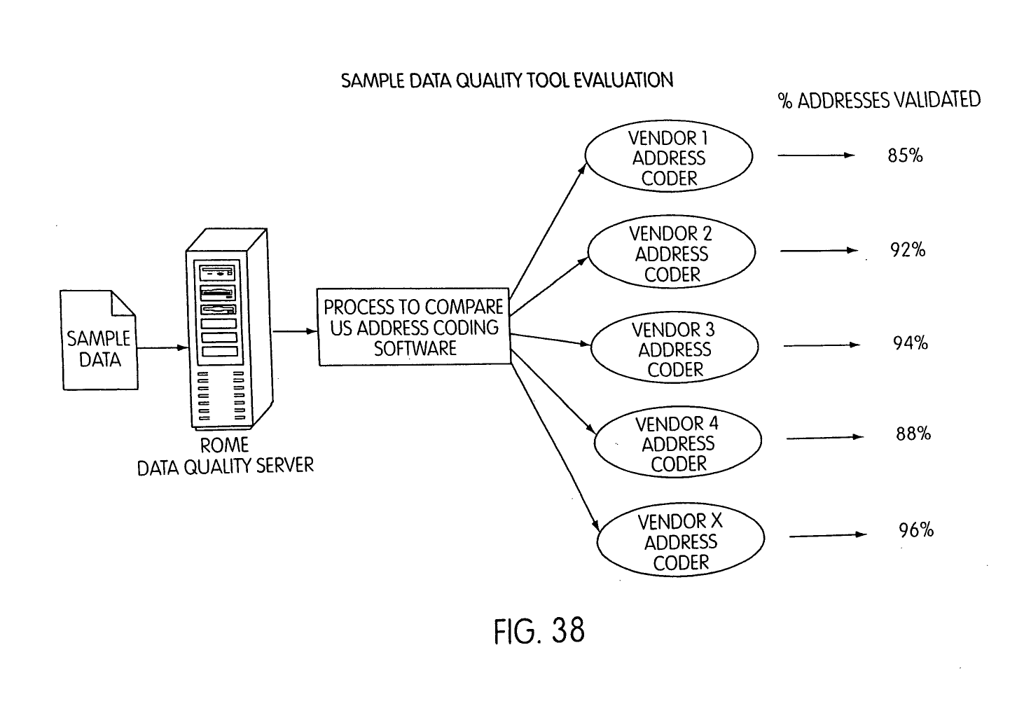

As another example, an embodiment of the enterprise business process management system may be directed to product comparison applications such as, but not limited to, defining, building and executing business processes that include functions from business applications involving address validation. In a particular example of such a business process, a business process may be created and executed which receives as input an individual's address, and then performs a multiple step process. In an embodiment, each step in the business process may include, for example, a different software vendor's address coder. Each step may attempt to receive as input the address and then validate that address against its own postal database. In an embodiment, a comparison of each vendors capabilities may then be performed and statistics could be created to see exactly which product performs the best under certain data conditions. FIG. 38 illustrates the comparison business process in accordance with an embodiment.

More generally, if an organization is trying to decide which software application or vendor provides the best functionality, then those products may be integrated under the enterprise business process management system and comparatively tested. Furthermore, any business process that compares different software vendors API calls can be included in such a process.

As another example, an embodiment of the enterprise business process management system may be directed to data mapping or transformation applications such as, but not limited to, defining, building and executing business processes that include functions from business applications involving data store transformation software. In a particular example of such a business process, a business process could be created and executed in which there the input data is received in a first format associated with one data store (e.g., first database) and the output data is provided in another data store (e.g., second database) format. In an embodiment, each process step may be a mapping from one field type to another, for example.

Finally, as another example, an embodiment of the enterprise business process management system may be directed to software-based mapping applications such as, but not limited to, defining, building and executing business processes that include functions from business applications involving information matching and database retrieval software. In a particular example of such a business process, a business process may include information matching and data store lookups for information related to call center operations. In particular, a call center operator may take a call from a customer in which the customer provides the call center operator name and address information. The call center operator may input the information using, for example, and interactive page, and then initiate a search request. The search request may cause the name and address information to be sent to a business process maintained by the enterprise business process management system that may perform, for example, the following steps:
a. Standardize the Name and Address Data
b. Create a Match Key
c. Perform a series of database lookups using the match Key created in step b
d. Each database lookup would return back some information that would be used to build a temporary record
e. After all of the database lookups have been performed the Output would be sent back the Call Center Reps screen.

Users of the enterprise business process management system, including management and executive users, may be provided different levels of visibility into enterprise-level issues such as, but not limited to, data quality issues, so that appropriate corrective action may be taken. In at least one embodiment, the enterprise business process management system may automatically make corrections to incorrect or errored data based on a trusted source of data. Because of the integrated view provided by the enterprise business process management system of the present invention, the shortcomings of vendor-specific approaches such as, for example, application-specific data checking processes, are minimized. In addition, total acquisition costs for data quality tools, for example, may be minimized for the enterprise through use of the integrated approach described herein, because the need to acquire and maintain many individual independent data quality applications is reduced.

Furthermore, in at least one embodiment, the business process server may be further configured to select and execute a set of preferred functions, wherein each preferred function is obtained from one of multiple different business applications. The business process server may select one function from among multiple similar functions provided by business applications based on, for example, a selection heuristic. An example of such a selection heuristic may be the percentage of errors detected by a function in a comparison of multiple similar functions applied to a given set of business application output data. Each of the business applications may or may not be products from different vendors. Alternatively, the function selection criteria may be specified by a user via an interactive page of the interface module. In this way, the enterprise business process management system may select a set of preferred or “best of breed” functions from among those offered by different business applications.

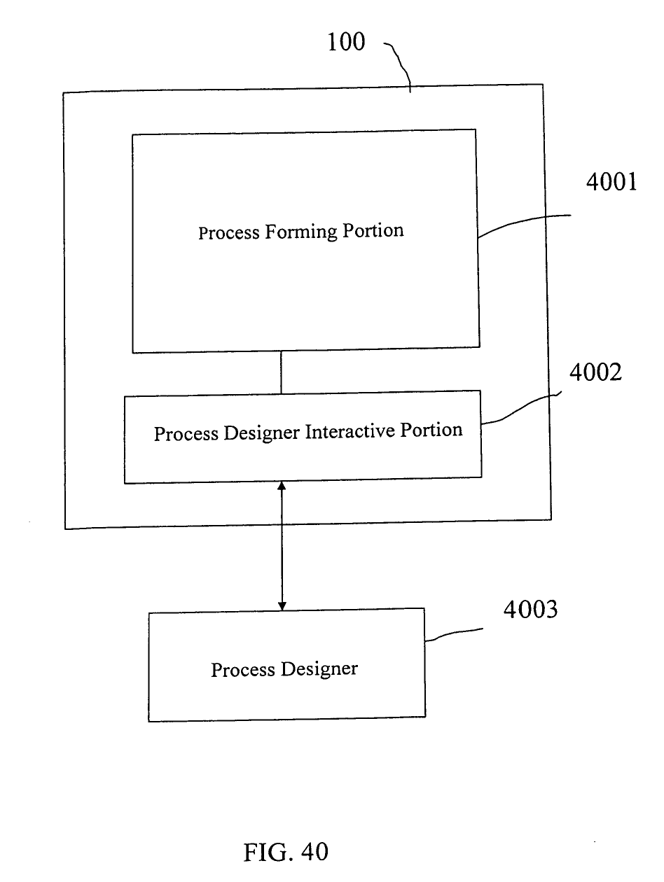

FIG. 40 shows a block diagram of the enterprise business process management system 100 as one example of a business process management system. The enterprise business process management system 100 comprises a process forming portion 4001 and a process designer interactive portion 4002. The process forming portion 4001 is an portion that creates or modifies a business process. The process designer interactive portion 4002 is an portion that interacts with a process designer 4003. The process designer 4003 may be a human who designs a business process. The process designer 4003 also may be an entity other than a human if it can design a business process. For example, the process designer may be a separate enterprise business process management system 100 or some other system or software, interactive or not.

The process designer interactive portion 4002 may interact with a process designer 4003 in various ways such as, but not limited to, via a screen display and a keyboard or via a screen display and a mouse. One example of a relatively sophisticated interaction is that the process designer interactive portion 4002 displays the process designer interactive page 2000 as shown in FIG. 20 to interact with the process designer 4003. The process designer 4003 inputs information for designing a business process used in the process designer interactive portion 4002. Here, the information for designing a business process is defined as any information that is used for designing a business process. One example of the information for designing a business process is that the process designer's placing a function identifier 2035 on the process designer interactive page 2000 as shown in FIG. 20. The process forming portion 4001 creates or modifies a business process based on the information received by the process designer interactive portion 4002.

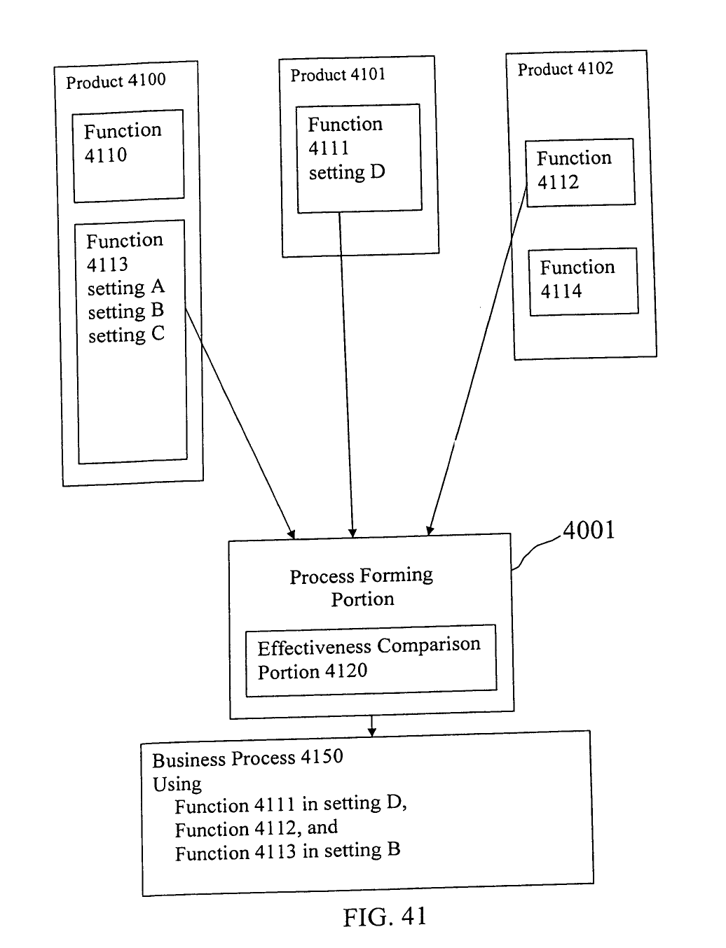

FIG. 41 shows a block diagram illustrating a use of multiple products by an enterprise business process management system 100. The process forming portion 4001 may utilize an unlimited number of products. In FIG. 41, the process forming portion 4001 utilizes three products 4100, 4101 and 4102 (which are illustrated by way of example, the process forming portion not being limited thereby). A product typically has a plurality of functions, but a product may have only one function. In addition, a function itself may be a product. Also, a business process, which incorporates plural functions and/or products, may constitute a function when the business process is used as a function. A business process created by the business process management system may be used recursively as a function. Also, a business process created by the business process management system may be used recursively as a product.

In FIG. 41, the product 4100 has functions 4110 and 4113. The product 4101 has a function 4111. The product 4102 has functions 4112 and 4114. FIG. 41 shows one example where the process forming portion 4001 selects functions 4111, 4112 and 4113 among functions 4110, 4111, 4112, 4113 and 4114 to create or modify a business process 4150. The products 4100, 4101 and 4102 may be same or different vendors' products. The process forming portion 4001 also selects settings and permits the selection of settings. Functions typically provide several settings that may be adjusted by businesses to meet their individual needs. Some functions may provide only one fixed setting that is not adjusted by businesses (or the process designer 4003). Some functions may have no settings at all. In FIG. 41, the function 4110 has three settings: setting A, setting B and setting C. The function 4111 has only one fixed setting D. The functions 4112, 4113 and 4114 do not have settings. FIG. 41 shows one example where the process forming portion 4001 selects setting B of function 4113 among settings A, B and C to create or modify the business process 4150. The business process 4150 uses the setting D of the function 4111, the function 4112, and the setting B of the function 4113. The business process 4150 may physically include the functions and the settings in the business process 4150 or may not physically include the functions and the settings but can access the functions and the settings outside of the physical location of the business process 4150 (such as when the functions are physically located at a different place but are accessible via wired or wireless connections). The process forming portion 4001 may select the same functions from the same or multiple vendors with different settings in one business process.

The selection of functions and settings in the process forming portion 4001 may be based on information received from the process designer interactive portion 4002. Also, the selection of functions and settings in the process forming portion 4001 may be based on an comparison of functions and/or settings. In FIG. 41, the process forming portion 4001 comprises an effectiveness comparison portion 4120. The effectiveness comparison portion 4120 is a portion that compares effectiveness of functions and/or settings in one contemplated embodiment. The process forming portion 4001 selects functions based on information received from the process designer interactive portion 4002.

One example of the information received from the process designer interactive portion 4002 is a selection of three function identifiers 2035 on the process step definition area 2015 as shown in FIG. 20 (for explanation purpose, we call entities that the three function identifiers represent as Functions X, Y and Z). Function X is realized by the function 4111 or 4114. Function Y is realized by the function 4112. Function Z is realized by the function 4113. The process forming portion 4001 selects the functions 4112 and 4113 as Functions Y and Z. The effectiveness comparison portion 4120 compares the effectiveness of the function 4111 and the function 4114 to select the function 4111 as Function X. Also, the effectiveness comparison portion 4120 compares effectiveness of the settings A, B, C of the function 4113 and select the setting B of the function 4113. The process forming portion 4001 creates the business process 4150 that uses the setting D of the function 4111, the function 4112, and the setting B of the function 4113.

There may be various ways for the effectiveness comparison portion 4120 to compare effectiveness. For example, the effectiveness comparison portion 4120 may evaluate the effectiveness of functions and settings by computer simulation. Alternately, the effectiveness comparison portion 4120 may evaluate the effectiveness of functions and settings by obtaining information from information included in vendors' products. The effectiveness comparison portion 4120 may compare the strengths and weaknesses of each vendor's functions and settings. The effectiveness comparison portion 4120 may provide for comparisons of the effectiveness of various functions and settings from different vendors for the selection of the most effective functions and settings to handle a specific enterprise issue, such as, for example, a data quality issue.

It should be noted that the effectiveness comparison portion 4120 also may evaluate the effectiveness of duplicates of functions and settings in addition to evaluating the effectiveness of different functions or settings. This comparison may be made to duplicates of functions and/or settings that are resident on the same system or platform or on different systems or platforms. For example, it is possible that the same function (or duplicates of a function) may be resident on different operating platforms and that the duplicates of the function, when executed on the different platforms, may perform differently. In one case, if a function is resident on a Windows-based platform, that function may operate at a slower speed that a duplicate of the function operating on a Linux-based platform. The effectiveness comparison portion 4120 would then evaluate the effectiveness of the functions (i.e., the duplicates of the same function) in the context of the platform on which they reside to select between the duplicates, as appropriate.

The effectiveness comparison portion 4120 may evaluate the effectiveness of functions and settings by comparing, among other factors, the speed and efficiency of the functions and settings. For example, if one setting or function operates at an unacceptably slow rate, that function or setting may result in the creation of a process that may not return a result within a preselected time limit. Accordingly, the effectiveness comparison portion 4120 may select a different setting or function to process the data within the preselected time limit. Alternatively, the effectiveness comparison portion 4120 may select between different settings and functions based on the trustworthiness, accuracy, etc., of the processed data. As would be appreciated by those skilled in the art, the effectiveness comparison may evaluate both the timeliness and the accuracy, among many other factors, of the returned result to compare the overall performance of a particular process, function, or setting.

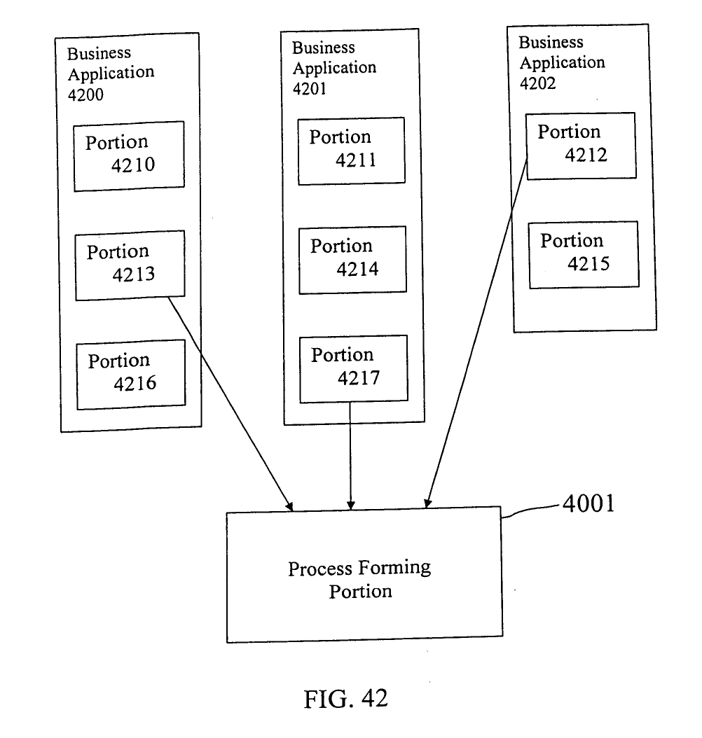

FIG. 42 shows a block diagram illustrating a use of multiple business applications by an enterprise business process management system 100. In an example shown in FIG. 41, a business application 4200 has functions 4210, 4213 and 4216. A business application 4201 has functions 4211, 4214 and 4217. A business application 4202 has functions 4212 and 4215. FIG. 41 shows one example where the process forming portion 4001 selects and combines the functions 4212, 4213 and 4217 to create or modify a business process 4250. All or a part of the functions 4210, 4211, 4212, 4213, 4214, 4215, 4216 and 4217 may include settings. The enterprise business process management system 100 may provide an enterprise to use “best of breed” business processes in combination to achieve increased effectiveness for the overall business process. Functions of multiple different business applications may be combined to form a new or modified business process in which the functions are chosen for a particular effect or other such criteria resulting in increased overall effectiveness. For example, several data quality processes, each of which may be obtained from the same or multiple different business applications, may be defined to comprise a single data quality business process that achieves a higher overall data accuracy percentage than would be possible applying each of the multiple data quality business applications alone. Each of the business applications may or may not be products from different vendors. The enterprise business process management system 100 may select a set of preferred or “best of breed” functions from among those offered by different business applications.

The enterprise business process management system 100 allows the process designer 4003 (or, alternatively a user) to add a product by entering information such as, but not limited to, a product name, product type, version, and product template. In order to input a version, the enterprise business process management system 100 may have a version input portion. A version input portion is a portion for inputting information about a version. FIG. 17 shows one example of a version input portion. FIG. 30 shows another example of a version input portion.

The enterprise business process management system 100 may allow the process designer 4003 (and/or a user) to input a platform of a product. A typical example of a platform is an operating system. The enterprise business process management system 100 may have a platform input portion. A platform input portion is a portion for inputting information about a platform. FIG. 32 shows one example of a platform input portion. The products 4100, 4101 and 4102 may be on same or different platforms. The business applications 4200, 4201 and 4202 may be on same or different platforms.

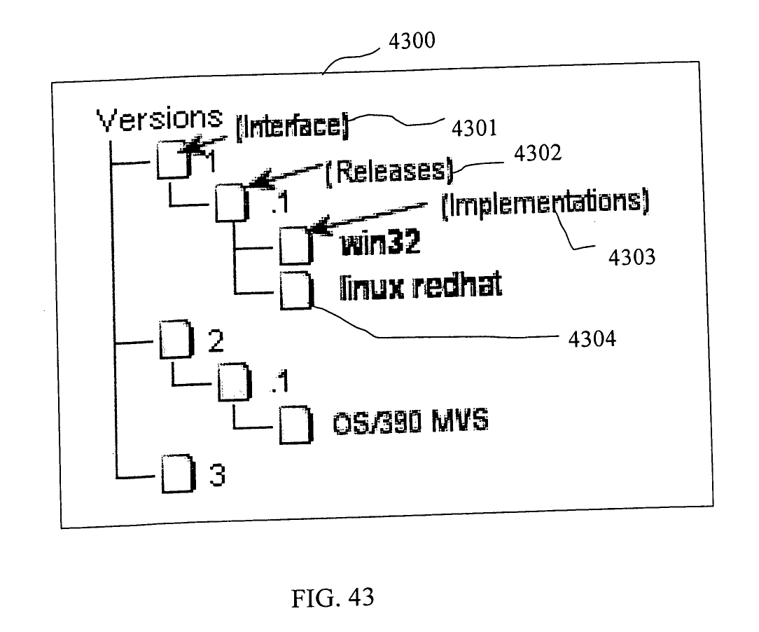

The enterprise business process management system 100 may have a version graphical display portion. A version graphical display portion is a portion that displays graphical information about a version. FIG. 43 shows a version page 4300 as one example of a version graphical display portion. The version page 4300 displays a tree structure as shown in FIG. 43. An interface 4301 is a first level of the tree structure. One interface 4301 may have one or more releases 4302, which are a second level of the tree structure. One release 4302 may have one or more implementations 4303, which are a third level of the tree structure. FIG. 43 shows that an interface 4301 and a release 4302 are combined to form a version number. For example, the interface 4301 having a number “1” and the release 4302 having a number “0.1” form a version number “1.1”. In this embodiment, the implementation 4303 does not constitute the version number. A name of an operating system is allocated to the implementations 4303. The implementations 4303 are typically operating systems, but may be any entity on which products or business applications are implemented. For example, if two word processor products having the same version number 1.1 are developed for two specific machines, the implementations may be machines.

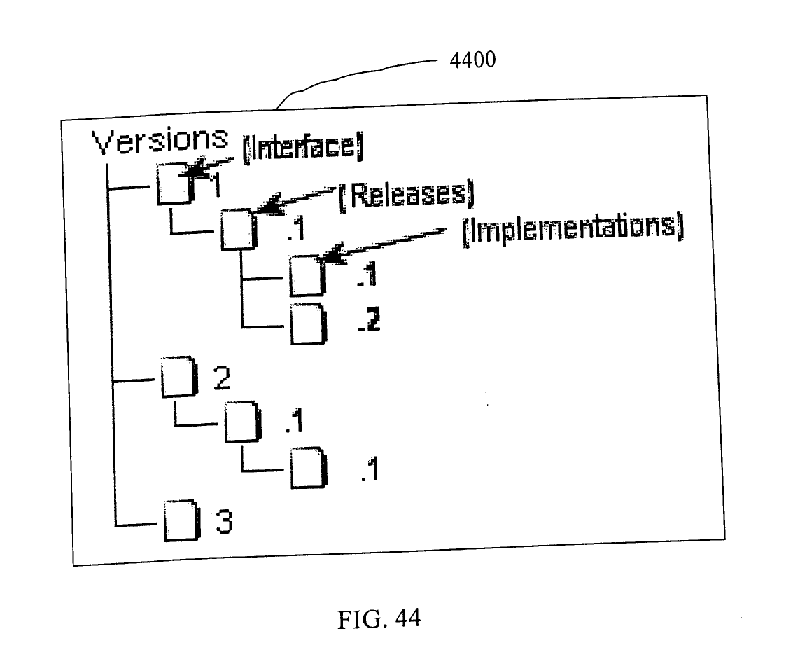

FIG. 44 shows another example of a version graphical display portion. In this embodiment, a number is allocated to the implementation 4403 and the implementation 4403 constitutes a version number. For example, when the interface 4401 has a number “1”, the release 4402 has a number “0.1” and the implementation 4403 has a number “0.1”, the version number becomes “1.1.1”.

All or a part of the interfaces 4301, 4401, releases 4302, 4402 and implementations 4303, 4403 may be represented by icons. In FIG. 43 and FIG. 44, they are represented by icons having the same shape. However, each icon may have a different shape, color, design, etc. Also, instead of icons, other indicators (e.g., simple dots or characters) may be used. Icons or other indicators may be folders. A folder is an indicator that opens or closes in accordance with a click operation, in one contemplated embodiment, among others. When a folder is clicked to open, the lower level of the tree is displayed on the screen. When a folder is clicked to closed, the lower level of the tree is hidden on the screen.

The process designer 4003 and/or a user may select a product used to create or modify the business process by selecting at least one of the indicators. For example, the process designer 4003 clicks an icon 4304 by a mouse cursor to select a product having version number 1.1 that is implemented on a particular operating system. This allows a user to use a version that is appropriate for a business process.

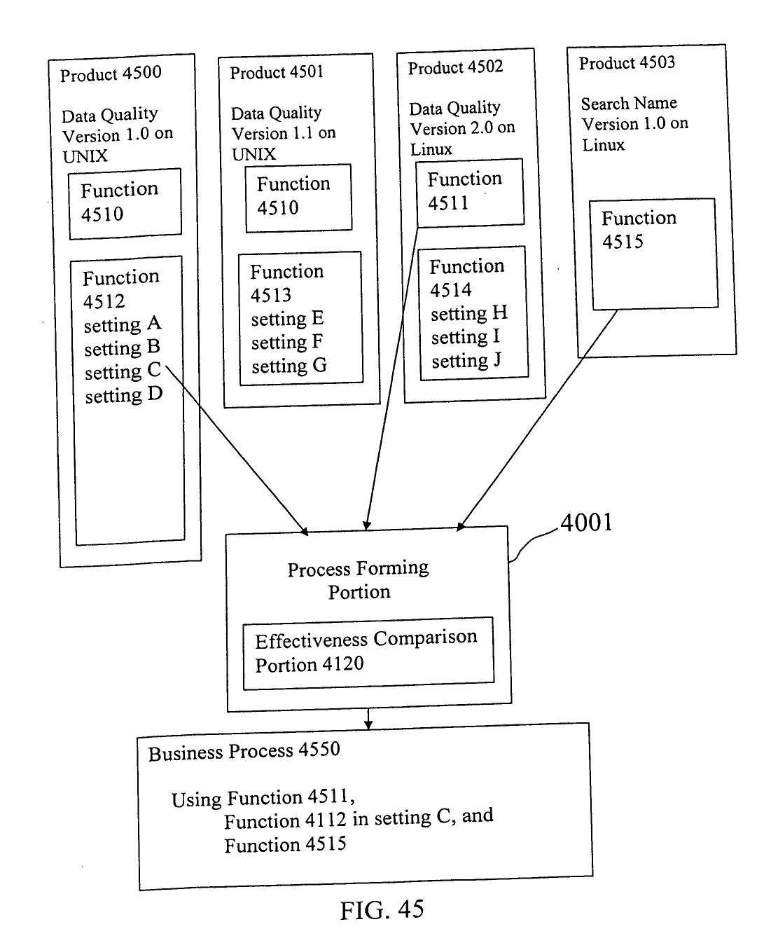

FIG. 45 shows a block diagram illustrating a use of multiple products having different versions by an enterprise business process management system 100. In this specification, products having different versions constitute different products even when names of products are the same. Also, in this specification, products having different platforms constitute different products even when names of products are the same. The enterprise business process management system 100 can select functions and settings from products having different versions and/or platforms to create or modify a business process. Also, the process designer 4003 and/or a user may select a product having a specific version and/or a platform used to create or modify the business process.

In FIG. 45, a product 4500 has a product name “Data Quality” and its version is 1.0 and its platform is UNIX. A product 4501 has a product name “Data Quality” and its version is 1.1 and its platform is UNIX. A product 4502 has a product name “Data Quality” and its version is 2.0 and its platform is LINUX. A product 4503 has a product name “Search Name” and its version is 1.0 and its platform is UNIX. The product 4500 has functions 4510 and 4512. The product 4501 has functions 4510 and 4512. The product 4502 has functions 4511 and 4514. The product 4503 has a function 4515. The function 4512 has settings A, B, C and D. The function 4513 has settings E, F and G. The function 4514 has settings H, I and J. In FIG. 45, the process forming portion 4001 selects the function 4511, the setting C of the function 4112, and the function 4515 to create or modify a business process 4550.

The products 4500, 4501 and 4502 have the same product name. The function 4511 is improved in effectiveness from the function 4510, but the function 4511 is only available on the platform of Linux. The process forming portion 4001 can improve performance by selecting the function 4511 to interact with a function on a different platform. From the consideration of compatibility with the product 4501, the function 4512 is selected in the setting C. The function 4515 is selected to combine with the functions 4511 and 4512. In this way, different versions or platforms of products having the same product name can be combined to create or modify the business process 4550. By mixing functions of different versions and platforms, the enterprise business management system 100 can create or modify a more effective business process than when only a product having one version and one platform is used.

As would be appreciated by those skilled in the art, the ability to organize and utilize effectively the different interfaces 4301, releases 4302, and implementations 4304 within a particular environment is a significant concern for many businesses today. With the structure described above, and with the enterprise business process management system 100 discussed herein, it is possible to accomplish this very task.

As would be appreciated by those skilled in the art, and in view of the foregoing, different implementations, releases, and versions are simply functions that may be utilized. For example, these are at least two ways in which the enterprise business process management system 100 may be used. First, if different implementations 4303 are employed on different portions of the system 100, the enterprise business process management system 100 may be used to replace an older implementation 4303 with a more up-to-date implementation 4303. Second, if it is desired to have different implementations 4303 running concurrently, the enterprise business process management system 100 may be configured to allow this operation.

After the passage of time, as implementations 4303, releases 4302, and interfaces 4301 are upgraded and replaced, the enterprise business process management system 100 may be configured to automatically search and replace older versions in favor of newer versions, thereby permitting a global upgrade simply and effectively.

As would be appreciated by those skilled in the art, an implementation fulfills the requirements of the interface. An implementation can be deployed on one or more machines, systems, or platforms that are capable of executing the implementation. This means that an implementation, while representative of a single version, can be deployed across M number of machines. A version also represents a scale factor within the system.

For example, when the process designer 4003 creates a process, the version and the specific embodiment of the version, whether it be an interface, release, or implementation, represents the range of machines on which the version may be executed across the system. How the system scales and the decisions by which scaling is accomplished are described below.

As indicated above, in the described embodiment, an interface represents the highest level of abstraction for a version and also represents the highest level of scalability. When an interface is used within a process, the system is notified that, when the process is executed, it has the complete range of releases and implementations from which to choose. Potentially, this represents an immense scale within which the system may execute the process.

In one example, if interface Tool.1 has N number of releases, represented by Tool.1.1, Tool.1.2, to Tool.1.N, and each release has P number of implementations represented Tool.1.1.P(1), Tool.1.2.P(2), to Tool1.N.P(3), when that interface is used in a process, the system may, if the process designer 4003 so decides, use every implementation (P) in every release (N) across every machine (M) where the implementation has been deployed. In essence, every machine is a potential participant in the execution of the process. To the process designer, the use of an interface represents a single version. To the system, the use of an interface corresponds to instructions on how much the system may be scaled to meet the needs of the process.

A release is much like an interface. A release, however, is more restrictive in terms of how the system may scale its operation to maximize usage. One difference between an interface and a release is that a release may be scaled to use the implementations that are encompassed only by that particular release (e.g., “children” of the release) and not to other releases. In this instance, to the process designer, the use of a release also represents a single version. To the system, the use of a release corresponds to instructions dictating how the system should limit its scale to so that implementations (that are children of the release) are the only implementation used to execute the selected step of the process.

In one contemplated embodiment, an implementation provides the least amount of scale within the system because it represents a maximum of M potential machines the system potentially may use to execute a particular process. It should be noted that, when a version is used in a process, the version represents a single step, which may or may not execute in sequential order, depending upon whether or not the step is dependent upon any previous steps. To the system however, the version does not represent a single step executable on only one machine, but may represent any number of machines which can be use for the execute this step.

The following example provides an example of the foregoing. Assume that a total number of transactions T are to be processed by a total number of machines M available to an interface. One step of the business process, if executed on the M machines in parallel, would require a processing time of t. The processing time t represents the total number of transactions T divided by the total number of machines M multiplied by the average time required to process each transaction. As is apparent, the larger the number of machines available to an interface, the more rapidly the business process may be executed, regardless of the processing time required by an individual machine.

As would be understood by those skilled in the art, each machine may not execute the step in the business process at the same rate. Accordingly, assuming that each machine handles the same number of transactions, the total processing time required to execute the step will be the processing time of the slowest of the machines available to the interface. To reduce further the total processing time, the interface may require certain of the faster machines to process a larger number of transactions than the slower machines. The interface may be set, therefore, to balance these factors to establish the most efficient processing for the variety of machines available to it.

In the simplest example, assume that 100 transactions are to be processed by the same process, and the process includes a step which is representative of an interface, and the interface represents a potential of 100 machines, each of which include implementations, then each transaction may be executed at the same time (in parallel). While the process itself is represented as a single step, the system scales to every potential implementation. In this example, assuming that each of the machines process the transactions at the same rate, the processing of the transactions may be completed in potentially 1/100^{th} the time that would be required if only a single machine were relied upon to execute the single step.

While the invention has been described with reference to the certain illustrated embodiments, the words which have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the claims thereto.

What is claimed is:

1. A business process management system, comprising:
a process designer interactive portion configured to receive information for designing a business process; and
a process forming portion configured to create or modify the business process based on the information received by the process designer interactive portion,
wherein the process forming portion is configured to select at least one of functions and settings from at least one of a plurality of products to create or modify the business process.

2. The system of claim 1, wherein the process forming portion comprises an effectiveness comparison portion that compares effectiveness of at least one of the functions and settings with others of the functions and settings.

3. The system of claim 1, further comprising:
an version input portion configured to input a version of at least one of the products.

4. The system of claim 1, wherein the products are on a plurality of platforms.

5. The system of claim 1, further comprising:
a platform input portion configured to input a platform of at least one of the products.

6. The system of claim 1, further comprising:
a version display portion that displays graphical information about a version.

7. The system of claim 6, wherein the graphical information includes information about a platform.

8. The system of claim 6, wherein the graphical information is a tree structure having a plurality of indicators.

9. The system of claim 8, wherein the plurality of indicators comprise:
an interface indicator representing an interface of the products;
an release indicator representing a release of the products; and
an implementation indicator representing an implementations of the products.

10. The system of claim 8, wherein the plurality of indicators are icons.

11. The system of claim 8, wherein the plurality of indicators are folders.

12. The system of claim 8, wherein the version display portion accepts an input of a selection of at least one of the plurality of indicators to select a product used to create or modify the business process.

13. The system of claim 1, wherein the functions comprise at least one of interfaces, releases, and implementations.

14. The system of claim 13, wherein releases comprise subsets of interfaces, and implementations comprise subsets of releases.

16. The system of claim 13, wherein the process forming portion comprises an effectiveness comparison portion that compares effectiveness of at least one of the interfaces, releases, and implementations with others of the interfaces, releases, and implementations.

17. The system of claim 13, wherein older interfaces, releases, and implementations may be replaced with newer interfaces, releases, and implementations.

18. The system of claim 13, wherein at least one of the interfaces, releases, and implementations permit the business process to be scaled.

19. The system of claim 18, wherein, to scale the business process, an interface directs a portion of a total number of transactions to a total number of available machines, each of which process the portion of the total number of transactions in parallel.

20. The system of claim 18, wherein, to scale the business process, a release directs a portion of a total number of transactions to a total number of available machines, each of which process the portion of the total number of transactions in parallel.

21. The system of claim 18, wherein, to scale the business process, an implementation directs a portion of a total number of transactions to a total number of available machines, each of which process the portion of the total number of transactions in parallel.

22. A business process management system, comprising:
a process designer interactive portion configured to receive information for designing a business process from a process designer; and
a process forming portion configured to create or modify the business process based on the information received by the process designer interactive portion,
wherein a process forming portion combines functions of a plurality of different business applications to create or modify the business process, the functions being selected for increasing overall effectiveness of the business process management system.

23. The system of claim 22, wherein the business process may be divided into smaller business processes based upon machines that are available to implement an interface.
